(19) United States
(12) Patent Application Publication
(10) Pub. No.: US 2007/0203786 A1
(43) Pub. Date: Aug. 30, 2007

(54) Learning-based performance reporting

(76) Inventors: Mark S. Nation, Hayward, CA (US); Southard Jones, New Castle, DE (US); Sridhar Tadepalli, Richmond, CA (US); Edward Suen, San Francisco, CA (US); Uma Prabhala, Hayward, CA (US)

Correspondence Address: CSA LLP, 4807 SPICEWOOD SPRINGS RD., BLDG. 4, SUITE 201, AUSTIN, TX, 78759, US

(21) Appl. No.: 10/185,870

(22) Filed: Jun. 27, 2002

(51) Int. Cl. G06F 11/34

(52) U.S. Cl. 705/11

(57) ABSTRACT

A method, system, and computer-readable medium for using learning activity information, such as for individuals in an organization, to provide a variety of benefits is described. In some situations, reporting functionality is available to provide information about completed learning activities, such as in the form of reports for presentation. In addition, learning activities may in some situations be rated based on learning activity criteria, such as to determine the amount or the effectiveness of the learning activities, and information about the learning activity ratings can then be provided in various ways. Learning activities can also be related to performance criteria in some situations, such as to correlate learning activities to corresponding changes in organizational or individual performance measures, and information about the relationships can then be provided in various ways. A variety of performance criteria and learning activity criteria may be used.

### TECHNICAL FIELD

The following disclosure relates generally to providing information related to performance, and more particularly to providing information indicating how learning-related activities relate to performance, such as to correlate learning activities of employees of an organization with productivity information for the organization.

### BACKGROUND

Many organizations track information about themselves and their members, and use that information for a variety of purposes. For example, business organizations may store limited information about the competencies of their employees (e.g., a list of employees that speak a particular foreign language) and about training completed by their employees (e.g., a list of employees that have completed a CPR training class), and may update such information occasionally to reflect changes. Organizations also typically track various information that reflects the performance of the organization (e.g., total sales information for a business organization that sells products and/or services), and may make some such performance information available to some or all of the organization members. Organizations increasingly employ various software applications to assist in the tracking of such information, as well as with the managing of interactions between the organization and other parts of the enterprise (e.g., customers, partners, suppliers, distributors, employees, etc.).

However, while limited performance information for an organization may be available to members of an organization, it is typically difficult for the members (and others outside the organization) to determine the factors that affect the performance information and the manner in which the performance information is affected. For example, when members of an organization improve existing competencies or acquire new competencies (e.g., based on completed training or other learning activities), such competency changes may provide beneficial impacts on various performance information for themselves and the organization, but it is typically difficult or impossible to determine what changes affect the performance information and in what manner the performance is affected.

Accordingly, it would be beneficial to track a variety of information related to learning activities and/or competencies for members of organizations, and to provide information indicating how such competency and/or learning activity information corresponds to performance information for the members and/or the organizations.

### BRIEF DESCRIPTION OF THE DRAWINGS

FIG. 1 shows a multi-layered system architecture within which the described techniques can be implemented.

FIG. 2 shows a block diagram of one embodiment of a system configuration in which the described techniques can be implemented.

FIG. 3 shows a block diagram illustrating a logical representation of a multi-layered architecture within which the described techniques can be implemented.

FIG. 4 illustrates a block diagram of one embodiment of an application framework within which the described techniques can be implemented.

FIGS. 5A-5C illustrate examples of competency-related information that can be tracked and used for employees of a business organization.

FIG. 6 illustrates an example of competency-related information that is defined for an organization.

FIGS. 7A-7D illustrate examples of receiving and using personalized learning activity recommendations.

FIGS. 8A-8D illustrate examples of providing information about the learning activities of various groups of one or more employees.

FIG. 9 illustrates an example of providing information about rating learning activities of employees based on a learning activity criteria.

FIGS. 10A-10D illustrate examples of providing information about how learning activities of employee relate to organizational performance criteria.

FIG. 11 is a block diagram illustrating an embodiment of a computing system suitable for providing the described techniques.

FIG. 12 is a flow diagram of an embodiment of the Personalized Learning Recommender routine.

FIG. 13 is a flow diagram of the Learning Activity Performance Relationship Reporter routine.

### DETAILED DESCRIPTION

I. Introduction

A software facility is described below that tracks various training courses and other learning activities completed or performed by individuals, and that uses such learning activity information to provide a variety of benefits. In some embodiments, the individuals are members of an organization (e.g., employees of a business organization), and the software facility is used by the organization to provide a variety of benefits to the organization and its members. In such embodiments, the learning activities for the individuals may also be referred to as “training” or “training activities”.

In particular, in some embodiments various reporting functionality is available to provide information about learning activities completed by individuals, such as in the form of reports presented to those individuals or to others responsible for them. Learning activity information for various groups of multiple individuals can also be aggregated and provided, with the groups of multiple individuals able to be selected in a variety of ways. For example, in some embodiments in which the individuals are employees of an organization, employees may be grouped based on project, organizational structure (e.g., a division or department), location, supervisor, job role, job category, recruiting source, etc. In addition, in some embodiments various learning activities can be associated together in various ways (e.g., based on the type or category of the learning activity and/or on resulting competencies), and learning activity information for the associated learning activities can be aggregated for one or more individuals before it is provided.

In addition, in some embodiments learning activities that are completed and/or in-progress can be rated on the basis of one or more of a variety of learning activity criteria (also referred to as “training activity criteria”), such as to determine the amount or the effectiveness of the learning activities. Information about the learning activity ratings can then be provided in a variety of ways. A variety of learning activity criteria may be available in various embodiments. For example, in some embodiments in which learning activity information is aggregated for groups of multiple employees, the training activity criteria may include the cost-to-train per employee (e.g., an average) and/or for the group (e.g., a total), the number of training activities and/or training hours completed per employee and/or for the group, the pass rate for training activities with specified completion criteria (e.g., training courses or exams) per employee and/or for the group, the training scores achieved per employee and/or for the group for training activities with corresponding scoring criteria (e.g., for the activities and/or for competencies resulting from the activities), the percent of payroll spent on training per employee and/or for the group, etc. The rating of learning activity information may also be specific to various periods of time (e.g., annually or quarterly) in at least some embodiments. In addition, in embodiments in which multiple learning activities are associated together, aggregated learning activity information for the associated learning activities can also be rated on the basis of one or more learning activity criteria and then provided.

In some embodiments, learning activities that are completed and/or in-progress can also be related to various performance criteria (also referred to as “performance measures”), such as to correlate learning activities to corresponding changes in organizational performance measures. Information about the relationships can then be provided. For example, learning activity for an individual may be related to various performance measures for that individual (e.g., individual productivity) and/or for a group of individuals to which that individual belongs (e.g., group productivity). Similarly, aggregated learning activity for multiple individuals may be related to various performance measures for that or other groups of individuals. As with learning activity information and learning activity criteria, the performance information to which the performance criteria is applied may be specific to various periods of time (e.g., annually or quarterly) in at least some embodiments. In addition, information about the relationship of aggregated learning activity for multiple associated learning activities to performance criteria can also be provided.

A variety of performance criteria may be available in various embodiments. For example, in some embodiments in which learning activity information is aggregated for groups of multiple employees of an organization, the performance criteria may include some or all of the following: various financial performance information (e.g., net or gross revenue, profit, costs, burden rate, etc.) for the group and/or the organization per employee (e.g., an average) and/or overall (e.g., a total); various non-financial productivity or quality metrics (e.g., call volume or length of time to resolve a problem for a help desk, the number or dollar amount of completed transactions for sales, the number of bug reports for software development, etc.) for the group and/or the organization per employee and/or overall; various internal performance metrics (e.g., employee score or rating during annual review, achievement of performance objectives for a specified period of time, timeliness or completeness of required administrative tasks, the number of promotions, project completion rate, etc.) for the group and/or the organization per employee and/or overall; various employee satisfaction metrics (e.g., voluntary and involuntary turnover, length of tenure, number of complaints, etc.) for the group and/or the organization per employee and/or overall, etc. Additional details are discussed below.

In addition, in some embodiments a variety of competency-related information for individuals may also be tracked and used to provide a variety of benefits. For example, in some embodiments a history of changes that occur in individuals' competencies is tracked, such as new competencies that are attained by the individuals and/or changes in skill levels (or “proficiency levels”) for existing competencies. In addition, in some embodiments gaps are identified between current competencies of individuals and target competencies for those individuals (e.g., based on required or preferred competencies for a current organizational position), and the individuals are provided with assistance in reducing or eliminating those competency gaps. After identifying one or more competency gaps for an individual, the facility can automatically identify training courses or other learning activities that if completed or performed by the individual would reduce or eliminate those competency gaps. The facility can also automatically detect the completion or performance of at least some such learning activities by individuals (e.g., training courses provided by an organization of which the individual is a member), and if so will automatically update the current competency information and resulting competency gap information for those individuals.

II. System Overview and Overall Architecture

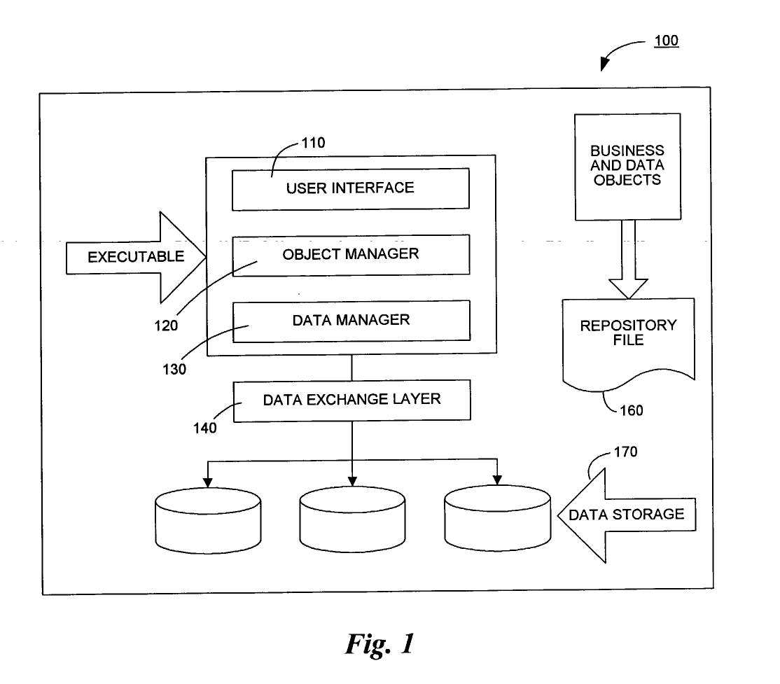

In one embodiment, a computing system with which the facility is integrated can be logically structured as a multi-layered architecture as shown in FIG. 1. In particular, the logical multi-layered architecture as shown in FIG. 1 provides a platform for common services to support various applications. These services may include a user interface layer 110, an object manager layer 120, a data manager layer 130, and a data exchange layer 140.

The user interface layer 110 may provide the applets, views, charts and reports associated with one or more applications. In one embodiment, various types of clients can be supported via the user interface layer 110. These various types of clients may include traditional connected clients, remote clients, thin clients over an intranet, Java thin clients or non-Windows-based operating systems, HTML clients over the Internet, etc.

The object manager layer 120 may be designed to manage one or more sets of business rules or business concepts associated with one or more applications and to provide the interface between the user interface layer 110 and the data manager layer 130. In one embodiment, the business rules or concepts can be represented as business objects. The business objects may also be designed as configurable software representations of the various business rules or concepts, such as accounts, contacts, opportunities, service requests, solutions, etc.

The data manager layer 130 may be designed to maintain logical views of the underlying data and to allow the object manager to function independently of underlying data structures or tables in which data are stored. In one embodiment, the data manager 130 may also provide certain database query functions such as generation of structure query language (SQL) in real-time to access the data. In one embodiment, the data manager 130 is designed to operate on object definitions in a repository file 160 that define the database schema. The data storage services 170 provide the data storage for the data model associated with one or more applications.

The data exchange layer 140 may be designed to handle the interactions with one or more specific target databases and to provide the interface between the data manager layer 130 and the underlying data sources.

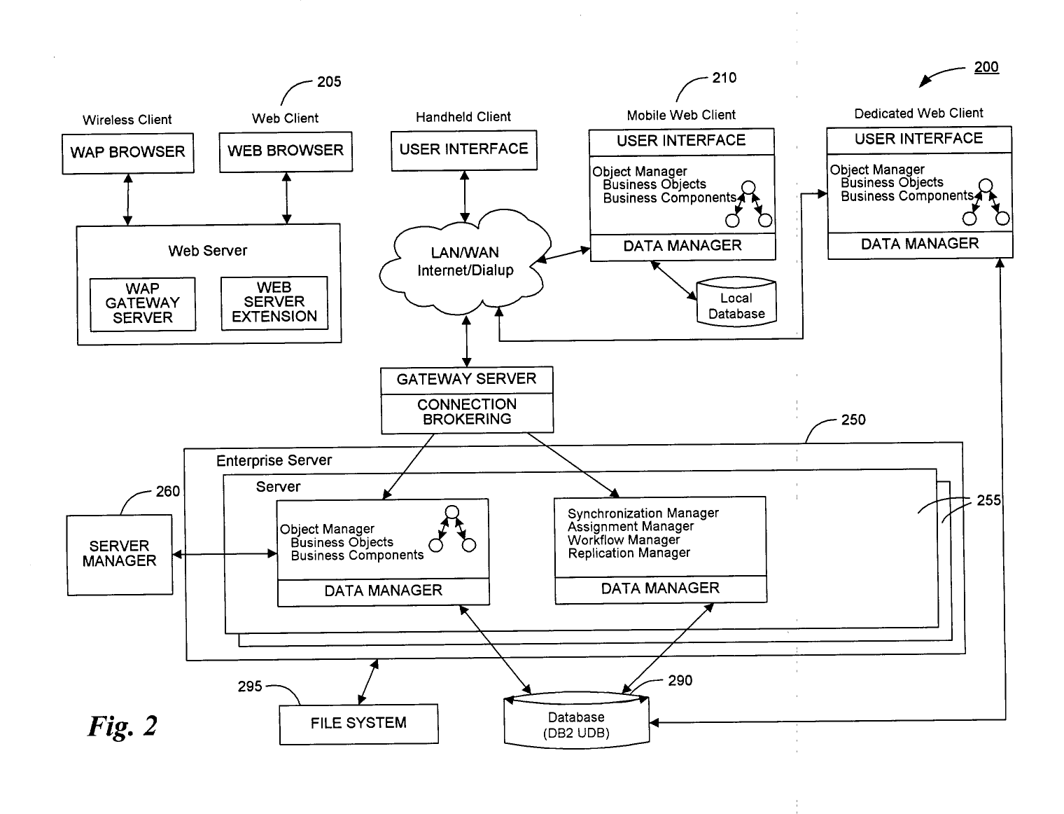

FIG. 2 shows a block diagram of one embodiment of a computing system configuration in which the facility can operate. In particular, the illustrated multi-layered architecture allows one or more software layers to reside on different machines. For example, the user interface, the object manager, and the data manager may all reside on the dedicated Web clients. For other types of clients such as the wireless clients, the object manager and data manager may reside on a system server. It should be appreciated and understood by one skilled in the art that the system configuration shown in FIG. 2 is for illustrative and explanative purposes, and may vary depending upon the particular implementations and applications of the described techniques.

In one embodiment, the system environment illustrated in FIG. 2 may include more than one database 290, and one or more subsets of the database can be created or replicated by a replication manager. In addition, mobile Web clients can have additional remote databases (also called local databases). In one embodiment, unless the remote or local databases associated with the mobile Web clients are defined as read-only databases, these mobile Web clients can create and update data locally that will be ultimately propagated up to the primary database when each mobile Web client synchronizes with the system server.

In one embodiment, the database 290 is designed to store various types of data including predefined data schema (e.g., table objects, index objects, etc.), repository objects (e.g., business objects and components, view definitions and visibility rules, etc.), and users' and customers' data. Dedicated Web clients and server components, including those that operate in conjunction with the other types of clients, may connect directly to the database 290 and make changes in real-time. In addition, mobile Web clients may download a subset of the server's data to use locally, and periodically synchronize with the server database through the system server to update both the local and the server database.

In some embodiments, various tables included in the database 290 may be logically organized into the following types: data tables, interface tables, and repository tables, etc. In addition, data tables may be used to store user business data, administrative data, seed data, and transaction data, etc. In one embodiment, these data tables may be populated and updated through the various applications and processes. Data tables may also include the base tables and the intersection tables, etc. In one embodiment, base tables may contain columns that are defined and used by the various applications. In one embodiment, the base tables are designed to provide the columns for a business component specified in the table property of that business component. In one embodiment, intersection tables are tables that are used to implement a many-to-many relationship between two business components. They may also hold intersection data columns, which store information pertaining to each association. In one embodiment, intersection tables provide the data structures for association applets.

In one embodiment, interface tables are used to denormalize a group of base tables into a single table that external programs can interface to. In one embodiment, they may be used as a staging area for exporting and importing of data.

In one embodiment, repository tables contain the object definitions that specify one or more applications regarding:
the client application configuration;
the mapping used for importing and exporting data; and
rules for transferring data to mobile clients.

In one embodiment, the file system 295 is a network-accessible directory that can be located on an application server. In one embodiment, the file system 295 stores the physical files created by various applications, such as files created by third-party text editors, and other data that is not stored in the database 290. In one embodiment, physical files stored in the file system 295 can be compressed and stored under various naming conventions. In one embodiment, dedicated Web clients can read and write files directly to and from the file system 295. In one embodiment, mobile Web clients can have a local file system, which they synchronize with the server-based file system 290 periodically. In one embodiment, other types of client such as the wireless clients and the Web clients can access the file system 290 via the system server.

In one embodiment, the enterprise server 250 is a logical grouping of the system servers 255 that share a common table owner or a database, point to a common gateway server, and can be administered as a group using server manager 260. In one embodiment, the connection to the gateway server can be established via TCP/IP. In one embodiment, the enterprise server 250 can be scaled effectively by deploying multiple system servers 255 in the enterprise server 250, thus providing a high degree of scalability in the middle tier of applications.

In one embodiment, the server 255 runs one or multiple server programs. It handles the incoming processing requests and monitors the state of all processes on the server. In one embodiment, server programs are designed and configured to perform one or more specific functions or jobs including importing and exporting data, configuring the database, executing workflow and process automation, processing to support mobile Web clients for data synchronization and replication, and enforcing business rules, etc. In one embodiment, the server 255 can be an NT Service (under Windows NT operating system) or a daemon (e.g., a background shell process) under UNIX operating system. In one embodiment, the server 255 supports both multi-process and multi-threaded components and can operate components in batch, service, and interactive modes.

In one embodiment, the server manager 260 is configured as a utility that allows common control, administration and monitoring across disparate programs for the servers 255 and the enterprise server 250. In one embodiment, the server manager 260 can be used to perform the following tasks: start, stop, pause, and resume servers 255, components, and tasks; monitor status and collect statistics for multiple tasks, components, and servers within an enterprise server; and configure the enterprise server, individual servers, individual components, and tasks, etc.

In one embodiment, the gateway server can be configured as a logical entity that serves as a single entry point for accessing servers. In one embodiment, it can be used to provide enhanced scalability, load balancing and high availability across the enterprise server. In one embodiment, the gateway server may include a name server and a connection brokering component. In one embodiment, the name server is configured to keep track of the parameters associated with the servers. For example, the availability and connectivity information associated with the servers can be stored in the name server. The various components in the system can query the name server for various information regarding the servers' availability and connectivity. In a Windows NT environment, the name server can be run as a NT service. In a UNIX environment, the name server can run as a daemon process. In one embodiment, the connection brokering component is used to perform load balancing functions such as directing client connection requests to an appropriate server (e.g., the least-busy server).

In one embodiment, as illustrated in FIG. 2, the various types of clients that can be supported by the system may include the following clients: dedicated Web clients, mobile Web clients, Web clients, wireless clients, and handheld clients, etc.

In one embodiment, dedicated Web clients (also called connected clients) are connected directly to a database server for data access via a LAN or WAN connection. In one embodiment, these connected or dedicated Web clients do not store data locally. These dedicated Web clients can also access the file system directly. In one embodiment, the user interface, the object manager, and the data manager layers of the multi-layered architecture reside on the dedicated Web client.

In one embodiment, the mobile Web clients are designed and configured for local data access and thus can have their own local database and/or local file system. In one embodiment, mobile Web clients can interact with other components within the system via the gateway server. Through synchronization, the modifications from the local database and the server database can be exchanged.

In one embodiment, a Web client runs in a standard browser format from the client's machine. In one embodiment, the Web client can connect to a system server 255 through a Web server. In one embodiment, the system server 255 is designed and configured to execute business logic and access data from the database 290 and file system 295. In one embodiment, the Web client described herein is designed and configured to operate in an interactive mode. In one embodiment, the interactive Web client framework as described herein utilizes dynamically created objects implemented in JavaScript on the browser side that correspond to objects on the server side. In one embodiment, these dynamically created objects on the browser side may include the current view and its corresponding applets, the current business object and the corresponding business components, etc.

In one embodiment, wireless clients are essentially thin clients enabled on wireless devices. The wireless clients can use a wireless application protocol (WAP)-based user interface to communicate and exchange information/data with the system server.

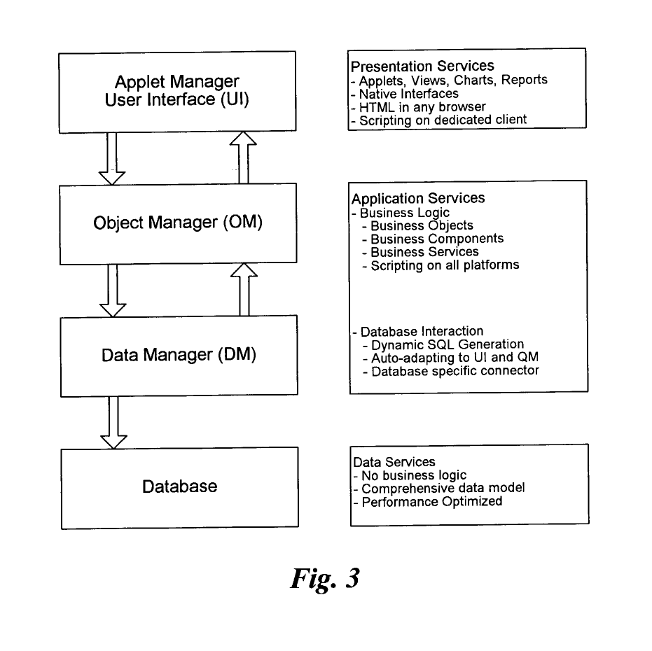

FIG. 3 shows a block diagram illustrating another logical representation of a multi-layered architecture. Again, the multi-layered architecture as illustrated in FIG. 3 provides the configured platform for various common services designed and to support the various applications. In one embodiment, these various services may include presentation services which correspond to an applet manager and user interface layer, application services which correspond to an object manager (OM) layer and a data manager (DM) layer, and data services which correspond to a database layer.

In one embodiment, the presentation services may be designed and configured to support various types of clients and may provide them with user interface applets, views, charts, and reports, etc. As described above, a large variety of clients may be supported including wireless clients, handheld clients, Web clients, mobile Web clients, and dedicated (connected) clients, etc.

In one embodiment, the application services may include business logic services and database interaction services. In one embodiment, business logic services provide the class and behaviors of business objects and business components. In one embodiment, database interaction services may be designed and configured to take the user interface (UI) request for data from a business component and generate the database commands (e.g., SQL queries) necessary to satisfy the request. For example, the data interaction services may be used to translate a call for data into DBMS-specific SQL statements.

In one embodiment, data storage services may be designed and configured to provide the data storage for the underlying data model which serves as the basis of the various applications. For example, the data model may be designed and configured to support various software products and applications including call center, sales, services, and marketing, etc., as well as various industry vertical products and applications such as eFinance, eInsurance, eCommunications, and eHealthcare, etc.

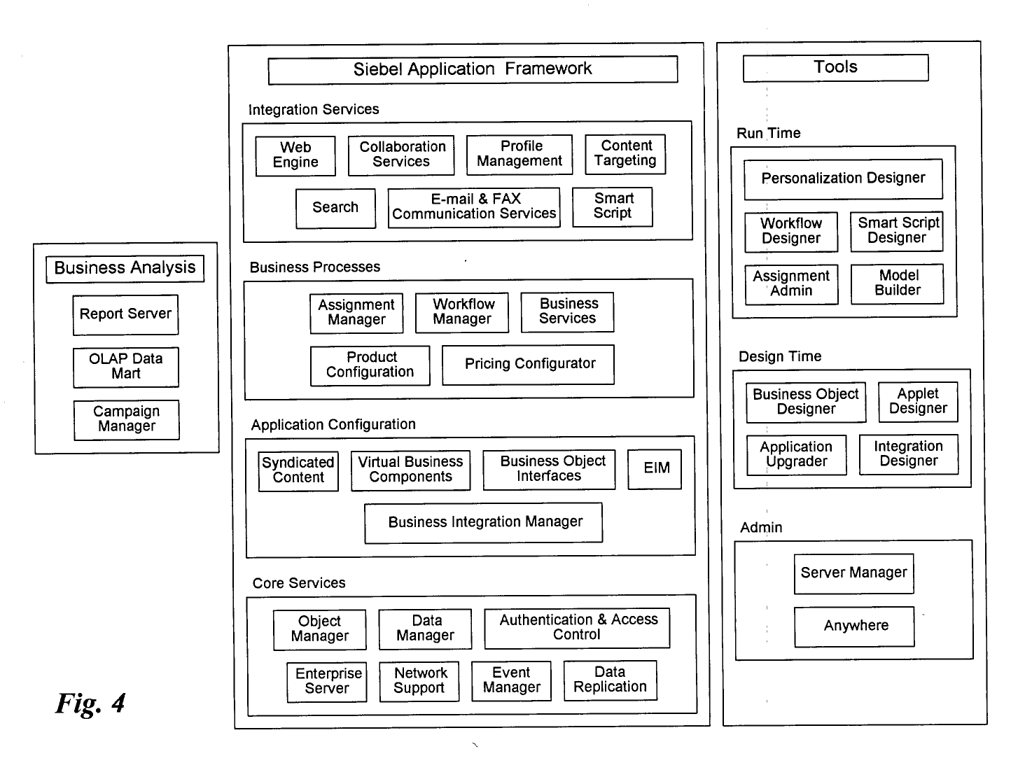

FIG. 4 illustrates a block diagram of one embodiment of an application framework. As illustrated in FIG. 4, the application framework may include various logical groupings of various types of services and various types of tools that can be used to design and configure particular applications based on business needs and environments.

In one embodiment, the core services are designed and configured to provide the framework in which the applications execute. In one embodiment, the core services may include the following:
the enterprise server, which is the middle-tier application server;
the networks that link all of these pieces together;
facilities like event manager and data replication, which allow sharing data between multiple installations of various applications as well as between the various applications and other external applications; and
the authentication and access control, the security facilities.

In one embodiment, application integration services may be designed and configured to allow the various applications built in accordance with this framework to communicate with the external world. In one embodiment, the various types of services in this logical grouping may be designed and configured to provide for real-time, near-real-time, and batch integration with external applications. For example, these integration services may be used to enable communications between external applications and the internal applications using available methods, technologies, and software products. In one embodiment, application integration services allow the systems or applications to share and replicate data with other external enterprise applications. Accordingly, these services allow a particular application or system to be both a client requesting information and a server having information requested from it.

In one embodiment, business processes services are designed and configured to allow the client to automate business processes through the application. In one embodiment, these various business process services may include the following:
assignment of tasks through Assignment Manager;
enforcement of business practices through Workflow Manager;
reuse of custom business logic through Business Services; and
ensuring proper product configuration and pricing through the Product Configurator and Pricing Configurator.

In one embodiment, creation of these business processes can be done through Run-Time tools such as Personalization Designer, Workflow Designer, SmartScript Designer, Assignment Administration Views, the Model Builder, etc.

In one embodiment, integration services may be designed and configured to provide the client with user interface and thin client support. In one embodiment, these may include capabilities for building and maintaining Web-based applications, providing Web support facilities such as user Profile Management, Collaboration Services and Email and Fax services, as well as advanced Smart Scripting, etc.

In one embodiment, design time tools may be designed and configured to provide the services to customize, design, provide integration points, and maintain the application. These various tools provide one common place to define the application.

In one embodiment, admin services are designed and configured to provide one place to monitor and administer the application environment. In one embodiment, these services allow the user to administer the application either through a graphic user interface (GUI) or from a command line.

III. Examples and Additional Details

For illustrative purposes, some embodiments of the software facility are described below in which specific types of training courses and other learning activities are available to employees of business organizations, in which specific types of productivity and other performance information is tracked for an organization and/or its members, and in which specific types of competencies are tracked and used by employees. However, those skilled in the art will appreciate that the techniques of the invention can be used in a wide variety of other situations, and that the invention is not limited to use with employees of business organizations or with the illustrated types of learning activities, performance information or competencies.

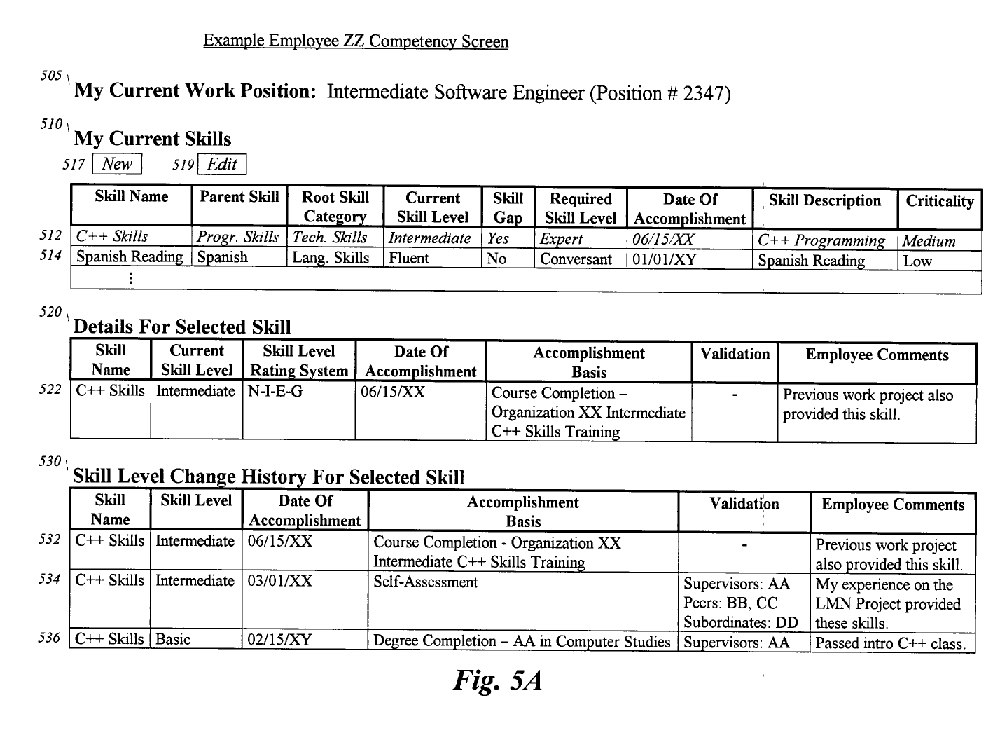

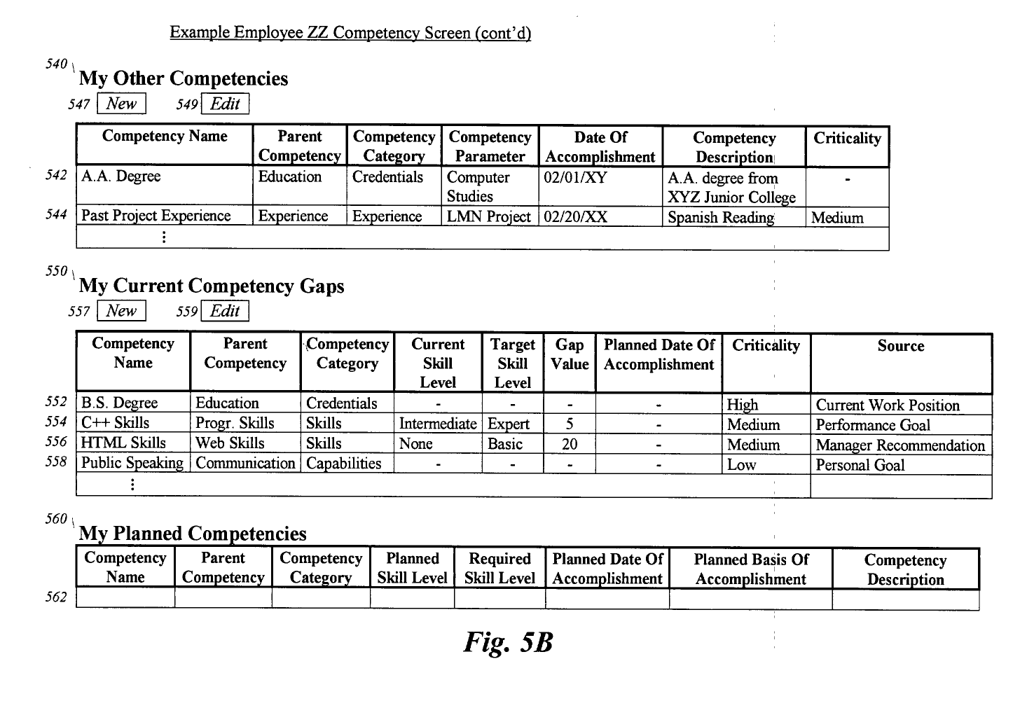

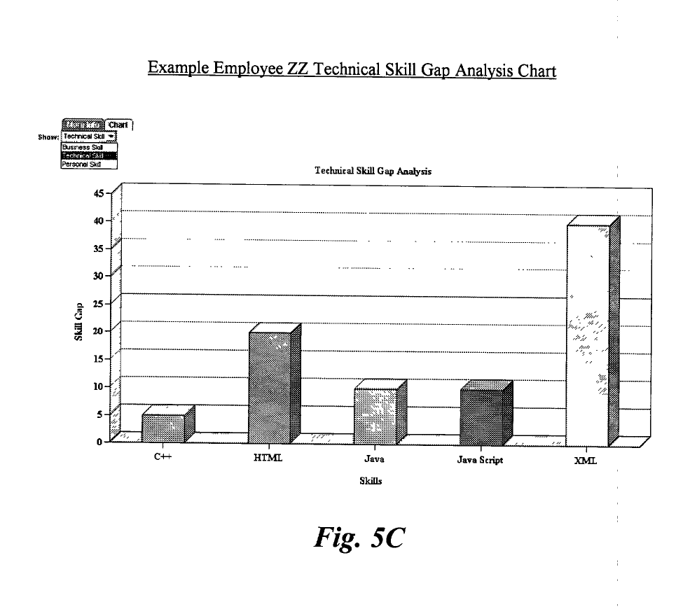

As one example of competency-related information that may be tracked and used for employees of a business organization, consider the information illustrated for an example Employee ZZ of an Organization XX in FIGS. 5A and 5B. In the illustrated embodiment, Organization XX makes a variety of information available to employees via a Web-based portal for the organization, and Employee ZZ has selected to review his competency-related information. As is shown in section 505 of the resulting screen of information, in this illustrated example Employee ZZ holds a current work position within the organization that has the unique identifier of 2347, with that work position being of a defined work position type for the organization of “Intermediate Software Engineer”. There are also various other sections of competency-related information for Employee ZZ that are illustrated on the screen, including a section 510 illustrating current skills, a section 520 illustrating details about a selected one of the current skills, a section 530 indicating history information for skill level changes for that selected skill, a section 540 indicating non-skill competencies of the employee, a section 550 indicating current competency gaps of the employee, and a section 560 indicating planned competencies of the user.

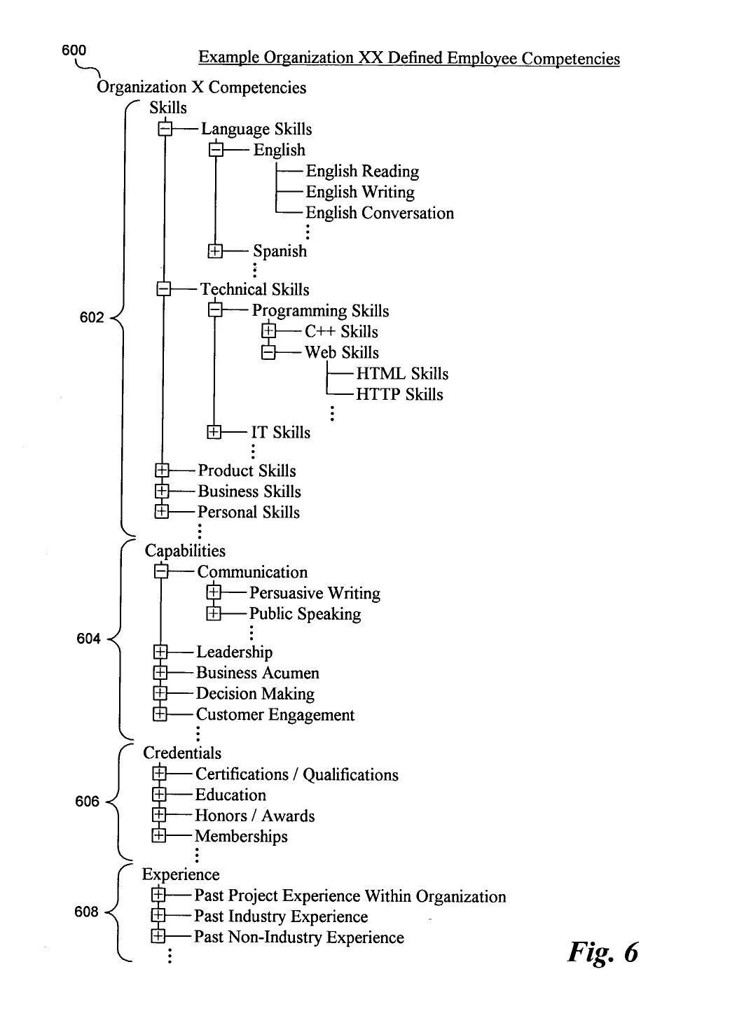

To provide a context for the competency-related information presented in FIGS. 5A and 5B, FIG. 6 illustrates an example of various defined competencies that have been previously specified for the organization. In particular, in the illustrated embodiment an administrative user (or “administrator”) for the organization has defined a competency hierarchy 600 for the organization, such as by modifying a default competency hierarchy provided by a third-party. The hierarchy in the illustrated embodiment can be defined to any depth desired by the administrative user. While competencies may be represented in a variety of ways, in the illustrated embodiment the competencies are hierarchically arranged in at least four competency groupings, those being a group 602 of various skills, a group 604 of various capabilities, a group 606 of various credentials, and a group 608 of various experiences. Competencies are selected to be grouped with the skills if they are attributes that have multiple corresponding skill levels amenable to measurement. Capabilities, conversely, are qualities which a person is determined to possess or not possess, but do not have multiple associated skill levels. Credential and experience competencies similarly do not have multiple associated skill levels, but may have associated parameters in the illustrated embodiment (e.g., a Masters of Science degree credential could have an associated parameter indicating the field of study or an associated class rank). Those skilled in the art will appreciate that competencies can be defined in other ways in other embodiments (e.g., a competency categorized as a capability for one organization could be categorized as a skill for another organization, or other organizations may not differentiate between different types of competencies in this manner), and can include a variety of types of information not illustrated or instead may lack some of the illustrated information.

In the illustrated embodiment, after specifying the competency hierarchy, an administrative user then assigns competency-related information to defined work positions and to learning activities that are available to employees. More generally, each business organization may have a variety of work position types that have been defined for the organization, with multiple filled work positions and work position openings sharing a single defined work position type. Each work position type can have one or more associated competencies, which in the illustrated embodiment can be defined as being required or preferred. In addition, for each competency associated with a work position type that is a skill, there is also a corresponding rating system having multiple defined skill levels (e.g., “Novice”, “Intermediate” and “Expert”, or integers 1-5) that is associated with that work position type. While not illustrated here, in some embodiments an administrative user may define an arbitrary number of rating systems with arbitrary skill levels, and associate any combination of skill and rating system to any work position type. In addition, while also not illustrated here, in some embodiments particular work positions of a defined type may be defined to have associated competencies that vary from the competencies associated with the defined type, such as defining a competency that is merely preferred for the defined type to be required for a particular work position.

In addition, the administrator can also associate competencies and rating systems (for skill-based competencies) with each of various learning activities available to employees, and can then specify skill levels that are expected to result from or possibly result from performance or completion of the learning activities by employees. Such learning activities can take a variety of forms, as discussed in greater detail below, including training courses and exams offered by the organization as well as learning activities provided by a known third-party, such as over the Web. Administrators can also specify a variety of other types of information related to learning activities, such as various prerequisites for a learning activity and/or multiple learning activities to be associated together (e.g., in a specified order) as a curriculum.

Returning now to FIG. 5A, a variety of competency-related information for Employee ZZ will now be discussed. As previously noted, section 510 includes various skill-based competency information for Employee ZZ. In particular, skills are shown in entries 512 and 514, and the skill in entry 512 with the name “C++ Skills” has been selected. Section 510 also includes interactive controls 517 and 519 in the illustrated embodiment to allow Employee ZZ to modify his own skill set, although in some embodiments some modifications (e.g., additions of new skills or skill levels) may need validation or other approval before taking effect. Some or all of the skills may also have associated criticality values, such as to show the importance of the possession of the skill to the employee (e.g., based on the current work position type) and/or to the organization.

Section 520 illustrates additional details for the selected skill, including not only a current skill level of Employee ZZ but also information about the achievement of that skill level. The skill level achievement information in the illustrated embodiment includes the date on which the skill level was achieved and a basis for the employee to have been rated as having that skill level, which in this example was completion of a course provided by Organization XX. In this example, the completed internal course was previously defined by an administrative user as providing an Intermediate skill level for the “C++ Skills” competency and as not requiring any additional validation. In addition, information such as the date of accomplishment and accomplishment basis was automatically added in this example to Employee ZZ's competency-related information upon completion of the course, such as by receiving that information from a learning module for the organization.

A history of skill level changes is also tracked for at least some skills in the illustrated example, and section 530 shows a skill level change history for the selected skill. Entries 532-536 of the section each show a previous change that occurred with respect to the skill for Employee ZZ. For example, Employee ZZ first attained a Basic skill level for the selected skill by completing an A.A. degree and then receiving a validation approval from his supervisor as possessing the Basic skill level. After later completing an internal project for Organization XX, Employee ZZ believed his skill level had progressed to a Intermediate level, and thus performed a corresponding self-assessment that was later approved by appropriate other employees in a 360 degree review. However, as Organization XX places a higher value on skills that are attained via courses than they do for those attained via self-assessments, Employee ZZ later completed an internal course that further validated his possession of an Intermediate skill level for the skill.

Section 540 summarizes a variety of non-skill competency information for Employee ZZ, which in other embodiments may be stored and/or presented in other manners (e.g., in a format more closely resembling a resume, or by separating credential, experience and capability information). While not illustrated, in some embodiments one of the competencies may be selected in a manner similar to that for the current skills, and corresponding additional details and/or competency change information may be presented for the selected competency. Section 540 also includes interactive controls in a similar manner to section 510. In other embodiments, information about skills and other competencies may be presented in an integrated manner.

Section 550 provides a variety of information about current competency gaps for Employee ZZ, with those gaps based on target competencies for Employee ZZ that are not among the current competencies of Employee ZZ. In this example, four competency gaps in entries 552-558 are illustrated. As shown by the Source field, such competency gaps (and their corresponding target competencies) can have a variety of sources, including required skills for Employee ZZ's current work position, performance or other goals set for Employee ZZ (e.g., as part of a yearly review process), explicit recommendations or requirements from his manager (e.g., of a useful skill that he might want to consider, such as to benefit himself and/or to provide additional aggregate skills to a group to which Employee ZZ belongs), and personal interests or goals of Employee ZZ that have been specified. In the illustrated embodiment, each competency gap has an associated criticality value, with the competency gaps presented in a ranked order based on those criticality values. These criticality values can be determined in a variety of ways, such as by being provided by the source of the competency gap (e.g., the “B.S. Degree” competency being a requirement for Employee ZZ's current work position with a High level of criticality), based on the source itself (e.g., Personal Goals having by default a Low criticality), etc.

Section 560 provides information about planned competencies of Employee ZZ, such as based on learning activities that have been scheduled, explicit competency goals that have been set, or a defined plan to reduce current competency gaps. In this example, Employee ZZ does not currently have any planned competencies.

FIG. 5C illustrates an alternative view of competency gap information for Employee ZZ, with the illustrated example focusing on technical skill gaps. As an alternative to presenting competency gap information in a table format ranked by criticality, such a chart can provide information showing a degree or amount of a gap relative to some performance measure, such as a defined requirement or a comparison to other comparable employees (e.g., those having work positions of the current or a future work position type). While not illustrated, a variety of interactive controls may also be provided to allow Employee ZZ to manipulate and modify the chart.

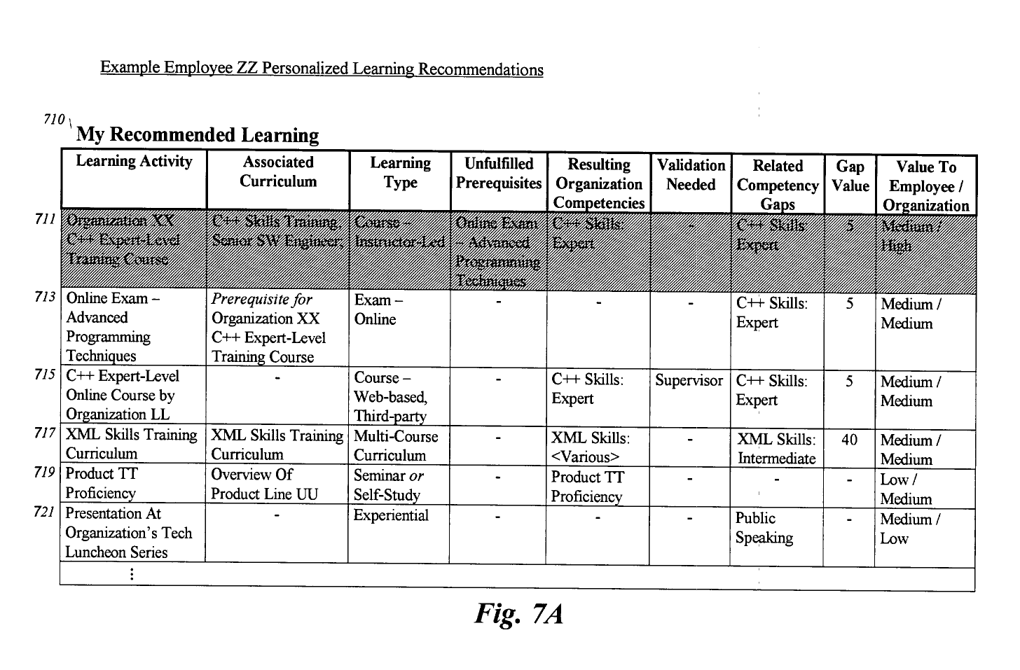

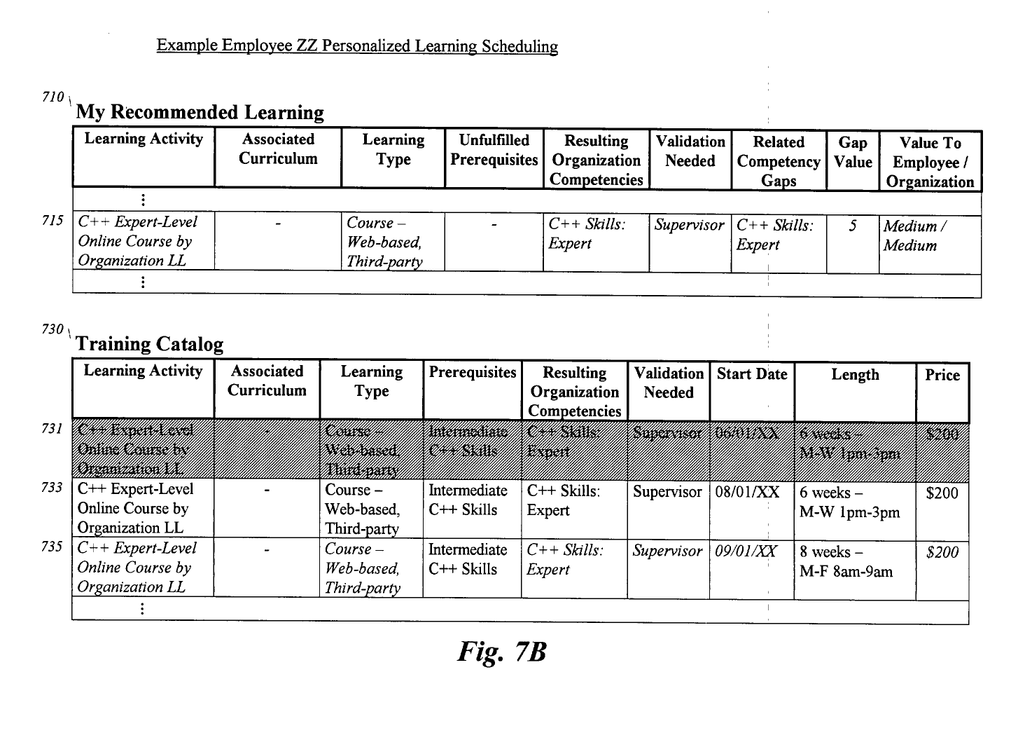

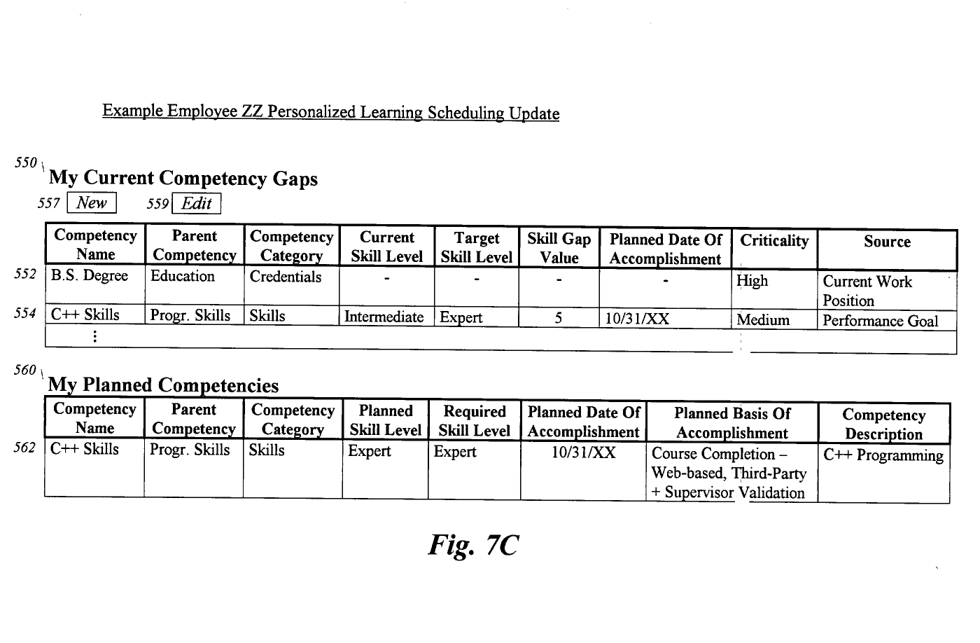

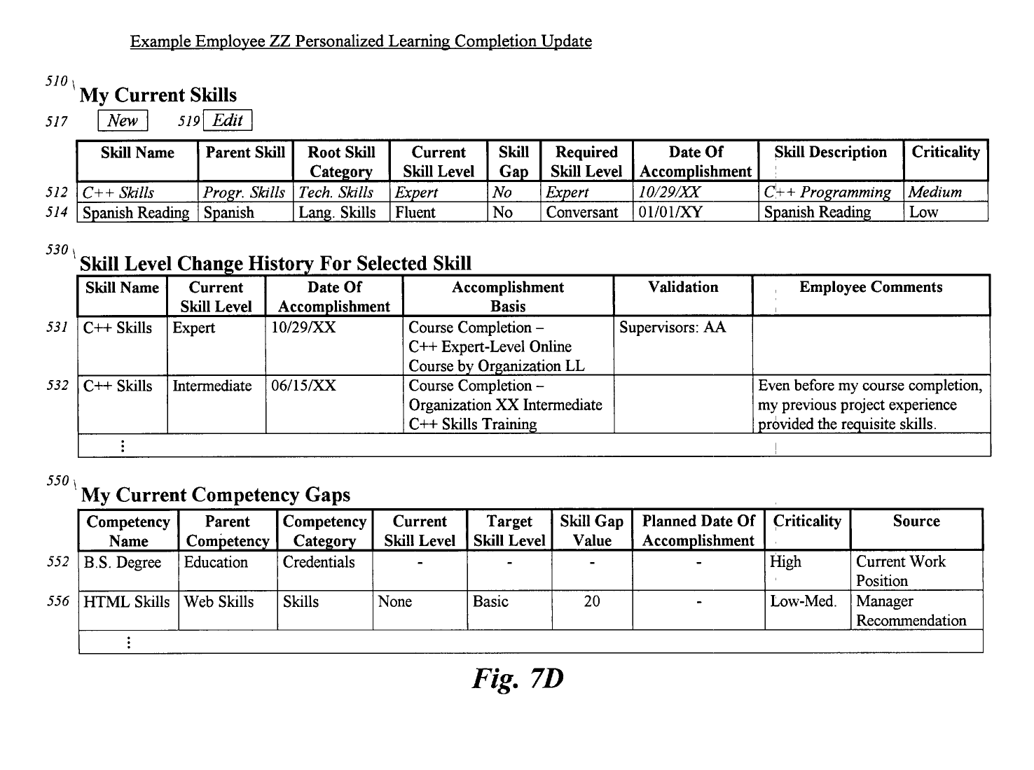

FIGS. 7A-7D illustrate examples of Employee ZZ receiving and using personalized learning recommendations. In particular, with respect to FIG. 7A, Employee ZZ is presented with a variety of learning recommendations illustrated in entries 711-721 of section 710, such as in response to a request for such information. In the illustrated embodiment, the personalized learning recommendations are based on gaps between Employee ZZ's current competencies and various target competencies that have been identified for him. For example, entries 711-715 correspond to a competency gap between Employee ZZ's current skill level of “Intermediate” for the “C++ Skills” competency and a target skill level of “Expert” for that competency, with the entries providing different options that can each be used by Employee ZZ to eliminate that competency gap. The learning activities can be of various types (e.g., courses internal to Organization XX, courses external to the organization, exams, self-study, experiential activities that provide learning by doing, etc.), and in the illustrated embodiment various related information such as unfulfilled prerequisites and associated curriculums is shown. As the learning activity in entry 711 has an unfulfilled prerequisite, in the illustrated embodiment it is displayed in a manner so as to differentiate it from the other entries (in a shaded or dimmed manner in this example) and is not selectable by Employee ZZ. In the illustrated embodiment, each of the learning activities also has associated values to the employee and the organization that can be determined in a variety of ways (e.g., based on the corresponding competency gaps and the importance of the source of those gaps), and the illustrated learning activities are ranked in the order of those values.

As is illustrated in FIG. 7B, Employee ZZ has selected the learning activity training course shown in entry 715 as a potential activity to be performed, and in response the system provides a variety of corresponding training catalog information in section 730 of the screen. In particular, information about particular upcoming instances of the selected training course are shown. In this example, the course instance shown in entry 731 conflicts with one or more other scheduled activities of Employee ZZ (e.g., based on information stored in his calendar or schedule), and thus that course instance is illustrated in a distinct manner from the course instances that do not have a conflict. After reviewing the illustrated information, Employee ZZ determines that he will take the course instance shown in entry 735, and selects that entry for registration.

After Employee ZZ has completed the scheduling of the course instance, various competency-related information for Employee ZZ is automatically updated. For example, as is shown in FIG. 7C, the planned competencies of Employee ZZ are updated to reflect the new competency that is expected to result from the scheduled training course, including a planned accomplishment date for the new competency based on the schedule for the course.

FIG. 7D provides an example of how competency-related information for Employee ZZ is automatically updated after completion of the training course. In particular, Employee ZZ's current skills are updated to show the new “Expert” skill level for the “C++ Skills” competency, and the skill level change history information is updated in a corresponding manner to show the date and basis for the new skill level. In addition, the previously existing competency gap for Employee ZZ based on the lack of the “Expert” skill level has now been eliminated. In this example, validation from Employee ZZ's supervisor M was required to confirm the new competency, and so that validation was automatically solicited from that supervisor upon completion of the training course. After that validation was received, the illustrated changes to Employee ZZ's competency-related information take effect.

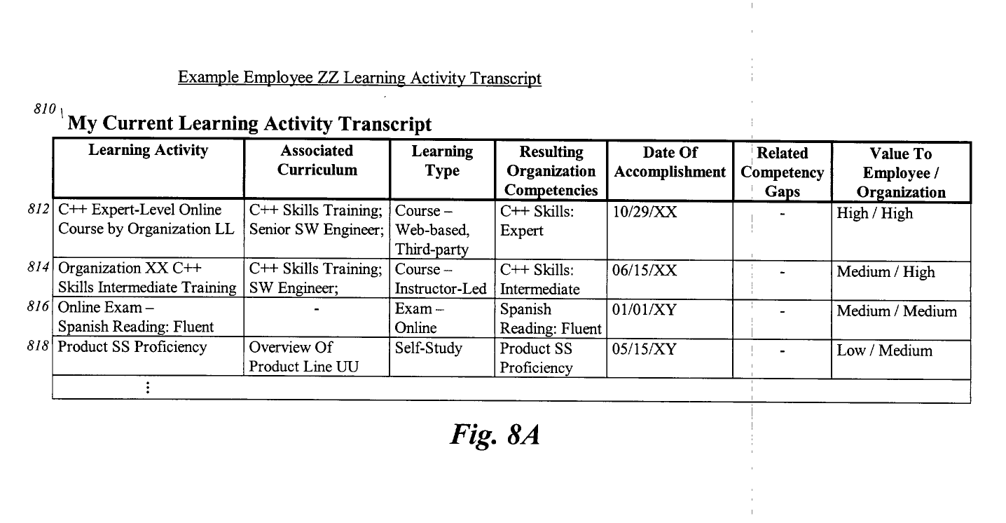

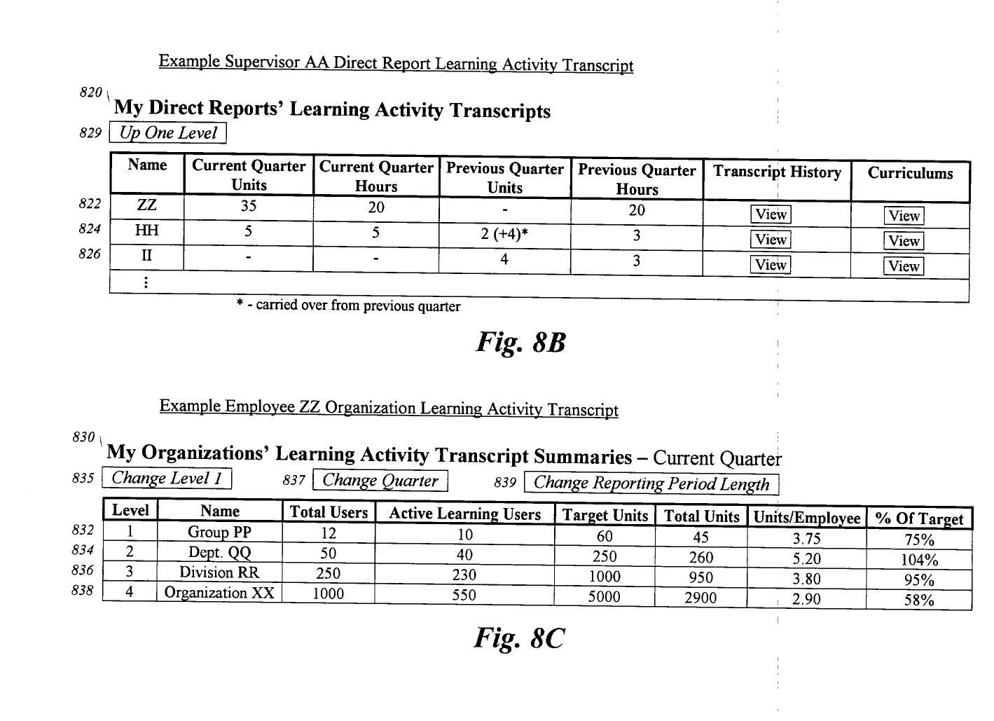

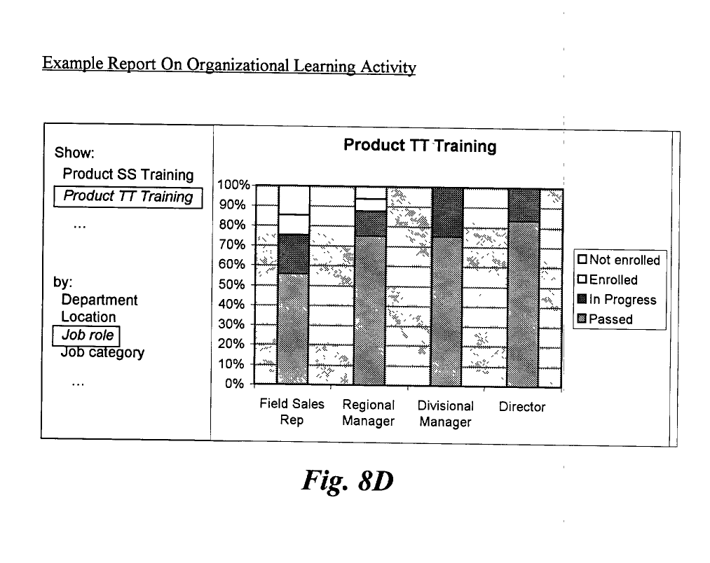

FIGS. 8A-8D illustrate examples of information about the learning activities of various groups of one or more employees that can be provided in various ways. In particular, FIG. 8A illustrates a learning activity transcript history 810 for Employee ZZ that provides various information about learning activities completed by Employee ZZ, such as may be presented to Employee ZZ or others via a Web-based portal from Organization XX. While not illustrated, information about planned or in-progress learning activities may also be provided, either in the illustrated or a distinct transcript.

In the illustrated embodiment, various learning activities are shown in entries 812-818, with the learning activity in entry 812 added automatically after completion of the previously discussed expert-level C++ training course. Each of the learning activities has various associated information presented, such as a date of accomplishment, an associated curriculum and a resulting competency.

FIG. 8B illustrates a learning activity transcript 820 for Supervisor AA that provides various information about learning activities completed by the direct reports of the supervisor. In the illustrated embodiment, summaries are shown for the current and previous quarters of the number of hours of learning activity completed and of the corresponding number of learning activity units received. In other embodiments, additional information may be shown, such as totals for all of the employees and/or additional details about specific learning activities completed. In addition, the supervisor in the illustrated embodiment can select any of the illustrated employees in order to view a detailed learning activity transcript for that employee (e.g., such as transcript 810 for Employee ZZ) or to view learning activity curriculums in which that employee is enrolled, and may also be able to view a variety of other related information about the employee. The transcript 820 also includes an interactive control 829 in the illustrated embodiment to allow the supervisor to modify the group of employees whose learning activity transcript is illustrated, such as by moving up to a next-higher level of the organization, and in other embodiments may include other controls (e.g., to change the period of time which the transcript covers and/or to change a level of detail of the information that is provided).

FIG. 8C illustrates an alternative learning activity transcript 830 that provides information about the learning activities of multiple employees, and in particular illustrates learning activity information about each of the organizational structures to which Employee ZZ belongs. In the illustrated embodiment, summaries are shown for the group, department, division and overall organization levels, and include information about target and actual numbers of completed learning activity units for the employees in each of the specified organizational structures. In addition, the user in the illustrated embodiment can select any of the illustrated organizational levels in order to view a more detailed learning activity transcript for that corresponding group of employees (e.g., such as transcript 820 for the direct reports of Supervisor M if that supervisor is the head of one of the illustrated organizational structures). The transcript 830 also includes several interactive controls in the illustrated embodiment to allow the user to modify the organizational structures whose learning activity transcripts are illustrated or to modify the time period to which the learning activity corresponds, and in other embodiments may also include other controls.

FIG. 8D illustrates an alternative view of learning activity information in graphical chart form rather than textual form, with the illustrated example providing organizational learning activity information about a specified type of learning activity (i.e., training on Product TT) and with the learning activity information for organizational employees aggregated by job role. In this illustrated embodiment, information is provided not only about completed training but also about in-progress and planned training. As is shown, the user in the illustrated embodiment can manipulate controls to select the specified learning activity and manner of aggregating employee learning activity information, and in other embodiments may have a variety of other interactive controls to manipulate and modify the chart. While not illustrated, in other embodiments the user may also select to provide learning activity information that is aggregated for multiple associated learning activities.

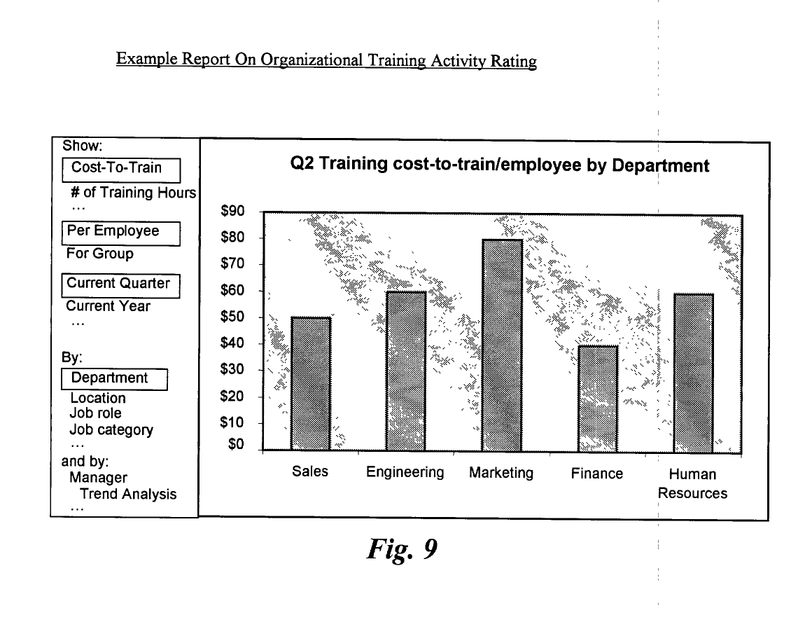

FIG. 9 illustrates an example of providing rating information for learning activities of employees based on a learning activity criteria. In particular, in the illustrated embodiment the rating information is provided in graphical chart form for a learning activity criteria that is the cost-to-train per employee. The learning activity information which is being rated is aggregated by organizational department and is for a specified quarter in this example. In this illustrated embodiment, the user can also select to further refine the provided information in various ways, such as to further aggregate the learning activity information by manager within the department or to illustrate a trend analysis of the ratings over time. As is shown, the user in the illustrated embodiment can also manipulate controls to change the specified learning activity criteria and/or the manner of aggregating employee learning activity information, and in other embodiments may have a variety of other interactive controls to manipulate and modify the chart. While not illustrated, in other embodiments the user may also select to provide learning activity information that is aggregated for multiple associated learning activities.

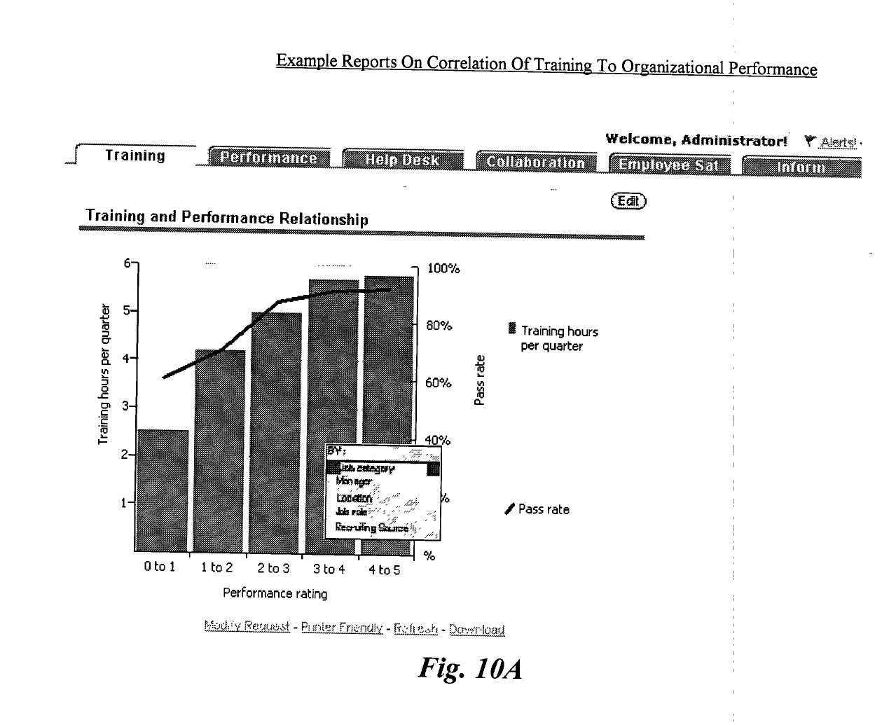

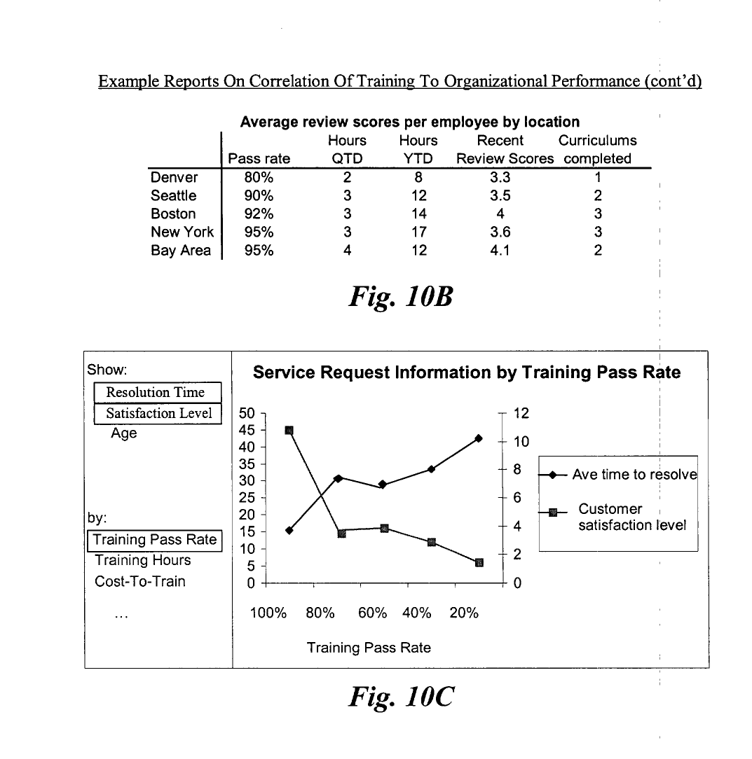

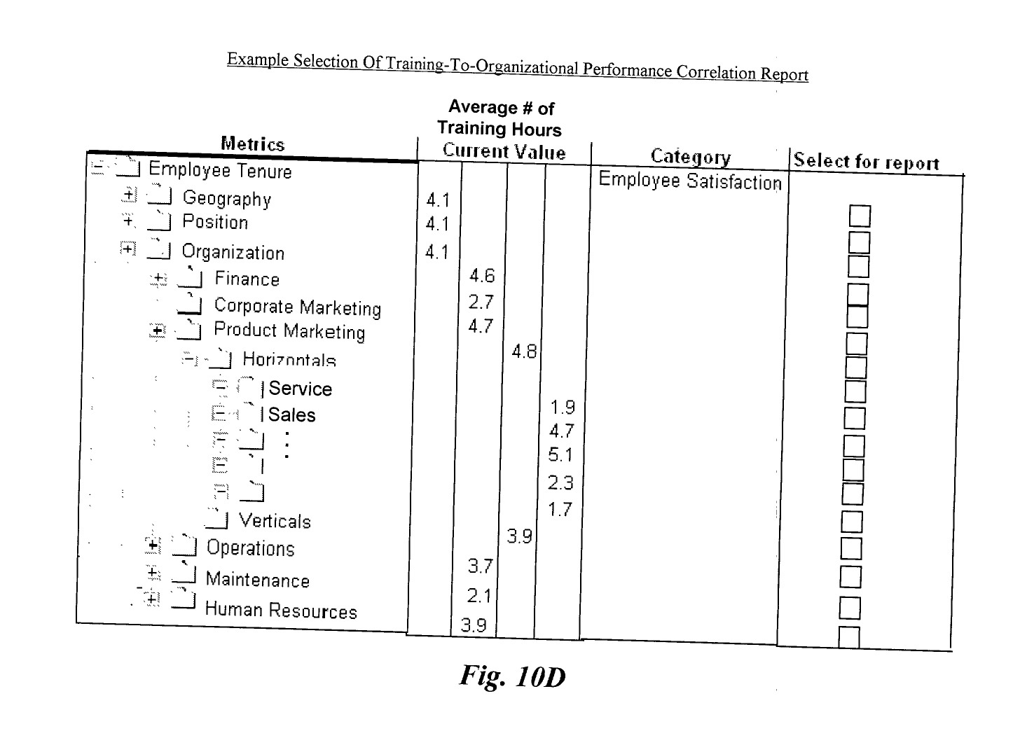

FIGS. 10A-10D illustrate examples of providing information about how learning activities of employee relate to organizational performance criteria. In particular, FIG. 10A includes a graphical chart that illustrates how the number of training hours completed per employee per quarter relates to average corresponding performance ratings and pass rates for the employees. While the illustrated learning activity information is aggregated for all learning activities and the corresponding performance criteria information is aggregated for the entire organization, in other embodiments the information can be aggregated in other manners. For example, in the illustrated embodiment a pop-up menu is provided to a user to allow the user to select to analyze the organizational information in various types of additional detail, such as by job category, manager, location, job role, and recruiting source. In other embodiments the user may be able to modify the information displayed in a variety of other manners, and may have a variety of interactive controls to manipulate and modify the chart. While not illustrated, in other embodiments the user may also select to provide learning activity information that is specific to subsets of the available learning activities and/or individual learning activities.

FIGS. 10B and 10C illustrate alternative examples of providing information about how learning activities of employee relate to organizational performance criteria. In particular, FIG. 10B includes a table that illustrates the average number of training curriculums completed and the average number of training hours completed per employee per quarter and per year for each of several geographical locations, and also illustrates how that completed training corresponds to average training pass rates and average recent employee performance scores. FIG. 10C includes a graph that illustrates how training pass rates relate to the average time to resolve customer service requests that are received and to the customer satisfaction with the service request resolution. As with the example information illustrated in FIG. 10A, the learning activity information and corresponding performance information in FIGS. 10B and 10C could be illustrated in other manners, and a variety of other types of learning activity information and performance information could be illustrated.

Table 1 illustrated below provides one example of a group of performance measures to which learning activity information can be related. Thus, for example, an organization's performance related to employee satisfaction can be rated against performance measures such as the turnover in number of employees, the length of employee tenure, or the satisfaction level of the employees (e.g., based on survey or other data). For each of these performance measures, the related performance information can be aggregated in various ways, such as the turnover information being aggregated by involuntary departures and/or by business unit and/or by manager and/or by period of time.

TABLE 1

| Category | Metric title | by | by | by | by |
|---|---|---|---|---|---|
| Employee | Turnover | Voluntary | Organization | Manager | Period of time |
| Satisfaction | # employees | Involuntary | Business unit | Hire Score | (historic data) |
| | | | Department | Review Score | |
| | | | Location | Years of experience | |
| | | | Region | Source | |
| | | | Manager level | Salary Level | |
| | | | Source type | Job role | |
| | | | Hire Score | Period of time | |
| | | | Review Score | (historic data) | |
| | | | Employee lifetime | | |
| | | | Job family | | |
| | | | Job role | | |
| | | | Position | | |
| | | | Salary Level | | |
| | | | Years of experience | | |
| | Employee | Organization | Manager | Period of time | |
| | Tenure | Business unit | Source | (historic data) | |
| | | Department | Hire Score | | |
| | | Location | Review Score | | |
| | | Region | Period of time | | |
| | | Manager level | (historic data) | | |
| | | Hire Score | | | |
| | | Review Score | | | |
| | | Source type | | | |
| | Satisfaction level | Organization | Manager | Period of time | |
| | | Business unit | Hire Score | (historic data) | |
| | | Department | Review Score | | |
| | | Location | Years of experience | | |
| | | Region | Source | | |
| | | Manager level | Salary Level | | |
| | | Source type | Job role | | |
| | | Hire Score | Period of time | | |
| | | Review Score | (historic data) | | |
| | | Employee lifetime | | | |
| | | Job family | | | |
| | | Job role | | | |
| | | Position | | | |
| | | Salary Level | | | |
| | | Years of | | | |
| | | experience | | | |
| Help Desk | Service Request | Area | Manager | Period of time | |
| | (SR) lifetime | Sub-area | Period of time | (historic data) | |
| | (calculated) | Organization | (historic data) | | |
| | # or % SR | Business unit | Job family | | |
| | FAQ use rate | Department | Job role | | |
| | (calculated) | Location | Status | | |
| | SR age | Region | Sub-status | | |
| | # Opens SRs | Manager level | | | |
| | SR resolution | Owner | | | |
| | time | Job family | | | |
| | | Job role | | | |
| | | Status | | | |
| | # suggestions | Organization | Manager | | |
| | # suggestions | Business unit | Period of time | | |
| | resulting in | Department | (historic data) | | |
| | change | Location | | | |
| | requests | Region | | | |
| | | Manager level | | | |
| | | Job role | | | |
| | | Job family | | | |
| Info Center | # or % | Navigation tab | Daily | Organization | Manager |
| | Individual | Screen (page) | Weekly | Business unit | Period of time |
| | users | Path of navigation | Monthly | Department | (historic data) |
| | accessing | Drill-down | Period of time | Location | |
| | # or % of web | (hyperlink) | (historic data) | Region | |
| | clicks | | | Manager level | |
| | # of sessions | | | Job role | |
| | | | | Job family | |
| | | | | Skill | |
| | | | | Period of time | |
| | | | | (historic data) | |
| | # stories | Stage | Approver (rank) | Period of time | |
| | | | Author | (historic data) | |
| | | | # of versions | | |
| Performance | Review score | Organization | Manager | Period of time | |
| Management | 360 score | Business unit | Source | (historic data) | |
| | MBO | Department | Hire Score | | |
| | achievement | Location | Review Score | | |
| | rate | Region | Job family | | |
| | Stack ranking | Manager level | Jon role | | |
| | (quartile, | Hire score | Recruiter | | |
| | quintile) - | Review score | Period of time | | |
| | distribution | 360 score | (historic data) | | |
| | # or % | Source type | | | |
| | objectives on | Employee lifetime | | | |
| | time | (tenure) | | | |
| | $ or % reviews | Job family | | | |
| | on time | Job role | | | |
| | (Delinquency) | Job code | | | |
| | Change in | Recruiter | | | |
| | Review Score | | | | |
| | # or % | | | | |
| | promotions | | | | |
| | Revenue/ | Profit Center | | | |
| | Employee | Cost Center | | | |
| | Profit/ | | | | |
| | Employee | | | | |
| | Cost/Employee | | | | |
| | (Burden rate) | | | | |
| | Employee | | | | |
| | payback | | | | |
| | period | | | | |
| | # or % of | Status | Organization | Period of time | |
| | reviews | | Business unit | (historic data) | |
| | # or % of | | Department | | |
| | objectives | | Location | | |
| | | | Period of time | | |
| | | | (historic data) | | |
| | Bonus payout | Organization | Manager | Period of time | |
| | Sick days | Business unit | Period of time | (historic data) | |
| | % Raise (merit | Department | (historic data) | | |
| | increase) | Location | Job role | | |
| | Benefits | Region | Job family | | |
| | Salary level | Manager level | Skill level | | |
| | Stock | Employee lifetime | | | |
| | Total | Review score | | | |
| | compensation/ | Job role | | | |
| | employee | Job family | | | |
| | | Skill level | | | |
| | | Source type | | | |
| | Bonus payout | as % Budget | Organization | Manager | Period of time |
| | Sick days | as % of Payroll | Business unit | Job role | (historic data) |
| | % Raise (merit | | Department | Job family | |
| | increase) | | Location | Skill level | |
| | Benefits | | Region | Period of time | |
| | | | Manager level | (historic data) | |
| | | | Employee lifetime | | |
| | | | Review score | | |
| | | | Job role | | |
| | | | Job family | | |
| | | | Skill level | | |
| | | | Period of time | | |
| | | | (historic data) | | |
| | Cost-per-hire | Organization | Source | Period of time | |
| | Hiring skill gap | Business unit | Years of experience | (historic data) | |
| | Time-to-hire | Department | Manager | | |
| | Time-to-start | Location | Hire Score | | |
| | Close rate (offer- | Region | Recruiter | | |
| | to-hire ratio) | Source type | Salary Level | | |
| | Interview to | Hire Score | Job role | | |
| | offer ratio | Employee lifetime | Period of time | | |
| | # promotions | Job family | (historic data) | | |
| | | Job role | Job family | | |
| | | Position | | | |
| | | Salary Level | | | |
| | | Years of | | | |
| | | experience | | | |
| | | Recruiter | | | |
| | | Hire date | | | |
| | # or % | Organization | Recruiter | Period of time | |
| | Open/closed | Business unit | Salary Level | (historic data) | |
| | requisitions | Department | Job role | | |
| | # or % | Location | Period of time | | |
| | Open/fulfilled | Region | (historic data) | | |
| | offers | Salary level | Source | | |
| | # or % | Job family | Years of experience | | |
| | Employee | Job role | Manager | | |
| | referrals | Position | | | |
| | Age of | Source type | | | |
| | requisition | Years of | | | |
| | Age of offer | experience | | | |
| | Age of candidate | Stage | | | |
| | # or % of | Hire date | | | |
| | applications | | | | |
| | # or % hires | | | | |
| Recruiting | Skill gap | Organization | Manager | Period of time | |
| | | Business unit | Job role | (historic data) | |
| | | Department | Job family | | |
| | | Location | years of experience | | |
| | | Region | Period of time | | |
| | | Manager level | (historic data) | | |
| | | Employee lifetime | | | |
| | | Job role | | | |
| | | Job family | | | |
| | | years of experience | | | |
| | Interview Score | Organization | Recruiter | Period of time | |
| | | Business unit | Period of time | (historic data) | |
| | | Department | (historic data) | | |
| | | Location | | | |
| | | Region | | | |
| | | Job role | | | |
| | | Job family | | | |
| | | Interviewer | | | |
| | | Recruiter | | | |
| | Allocated | % of budget | Organization | Period of time | |
| | recruiting | | Business unit | (historic data) | |
| | funds | | Department | | |
| | | | Location | | |
| | | | Region | | |
| | | | Period of time | | |
| | | | (historic data) | | |
| Teams | Virtual meeting | Organization | Period of time | Period of time | |
| | time | Business unit | (historic data) | (historic data) | |
| | Project | Department | Manager | | |
| | completion | Location | | | |
| | rate | Region | | | |
| | # or % of active | Team | | | |
| | teams | | | | |
| | # or % of | | | | |
| | employees on | | | | |
| | team | | | | |
| | # or % of | | | | |
| | employees | | | | |
| | using virtual | | | | |
| | meeting | | | | |

FIG. 10D illustrates one example of a user interface with which a user can select a manner of grouping performance information to which learning activity information will be related. In particular, in the illustrated embodiment, learning activity information of the type average number of training hours and performance measures within the category Employee Satisfaction have been selected. The user can then select one or more corresponding performance measures from a hierarchical pane entitled “Metrics” (with the metric “Employee Tenure” shown), and can next select one or more ways to group the organizational information (with the illustrated examples including “Geography”, “Position” and “Organization”) and then successively select additional refinements (e.g., by selecting “Product Marketing” within the organizational structure and then selecting “Horizontals” within Product Marketing). Those skilled in the art will appreciate that types of learning activity information and performance measures can be selected in other manners in other embodiments.

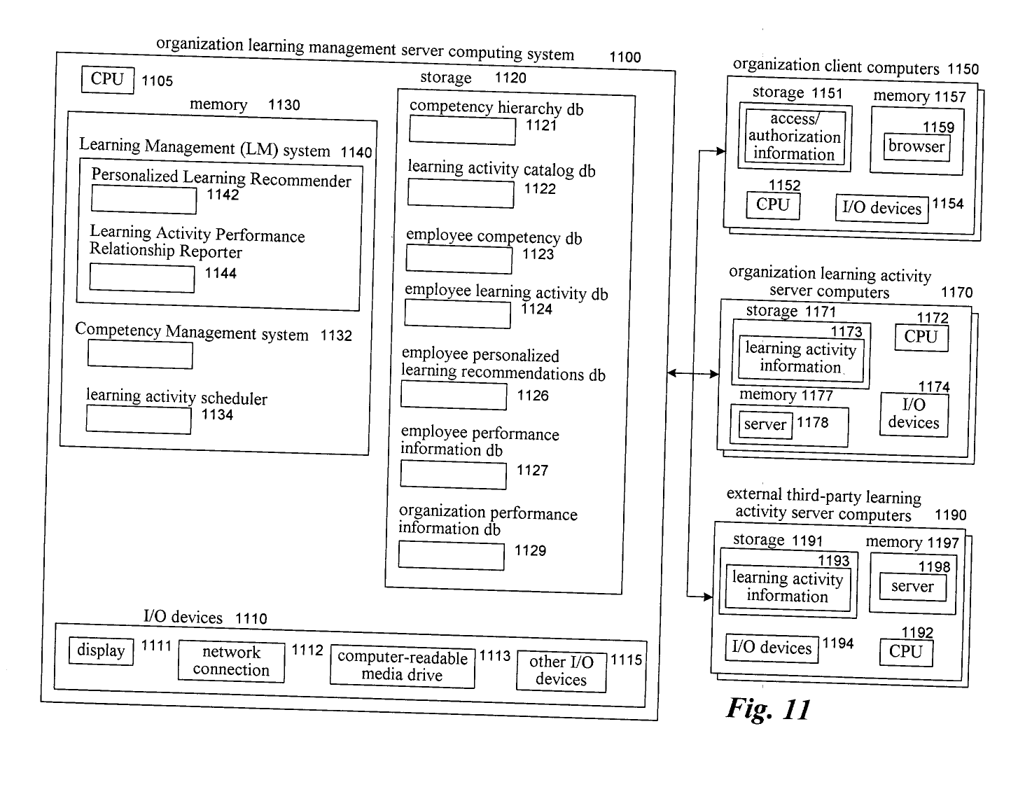

FIG. 11 illustrates a computing system suitable for executing an embodiment of a Learning Management (LM) system facility capable of implementing the described techniques. In particular, an organization learning management server computing system 1100 is illustrated that provides various learning-related functionality to users within an organization, and various organization client computers 1150 are illustrated from which such users can interact with the learning management server. In addition, various server computers are available in the illustrated embodiment to provide learning activity information (e.g., online courses or exams) to users of the client computers, including one or more organization learning activity server computers 1170 and one or more third-party external Web server computers 1190.

The learning management server includes a CPU 1105, various I/O devices 1110, storage 1120, and memory 1130. The I/O devices include a display 1111, a network connection 1112, a computer-readable media drive 1113, and various other I/O devices 1115. An embodiment of the LM system 1140 is executing in memory, and it includes a Personalized Learning Recommender component 1142 and a Learning Activity Performance Relationship Reporter component 1144. Various other software modules may also be executing in memory on this or other computing systems to provide functionalities to users, such as a learning activity scheduler component 1134 to assist in providing learning activities to users and a competency management system 1134 to provide various competency-related functionality to users.

As discussed in greater detail below, the LM system can provide various functionalities to users, and may be accessed by users in a variety of ways. For example, some users may have physical access to the learning management server, and if so may use the I/O devices 1110 to interact with the LM system. Alternatively, other users may use the client computer systems 1150 to remotely access the LM system (e.g., via the World Wide Web, such as over an intranet and/or the Internet). Such users may include employees accessing the system on their own behalf, managers accessing the system on behalf of groups which they manage or with which they are otherwise associated, and/or administrators accessing the system for maintenance and configuration purposes.

In the illustrated embodiment, various learning activity-related information is defined for the organization, such as a learning activity catalog in database 1122 on storage that includes information about available learning activities. Competency-related information (e.g., a hierarchy of competencies and associations of skill level rating systems to skill-based competencies) is also stored in this example embodiment in a database 1121 on storage, such as for use by the Competency Management system. In some embodiments, such learning activity information and competency information may be initially defined by one or more administrative users via the LM system and/or the Competency Management system (e.g., by modifying default information supplied with the systems or by creating such information in an independent fashion), while in other embodiments default competency-related and learning-related information may instead be used. Other information related to learning activities may also be stored in database 1122 or elsewhere, such as associated competency information (e.g., competencies that typically result from completion of those learning activities) and/or information about various learning activity criteria with which learning activity can be rated and/or reported. In addition, in the illustrated embodiment learning activity server computers 1170 and 1190 also store learning activity information 1173 and 1193 respectively on their storages 1171 and 1191 to provide information about learning activities that they provide. In other embodiments, learning activity information may be stored in other manners, such as in a single database (e.g., database 1122) or in other distributed manners.

Information about available learning activities can be used to provide various benefits to users. For example, in some embodiments users may interact with the learning activity scheduler component to identify, schedule and participate in available learning activities. The learning activity scheduler component can obtain information about available learning activities from the learning activity catalog database and/or from the learning activity server computers, with the illustrated learning activity servers including executing servers 1178 or 1198 in memory to provide learning activity information to the learning activity scheduler component and/or to the client computers, as well as CPUs 1172 or 1192 and various I/O devices 1174 or 1194.

Employees can also interact with the Personalized Learning Recommender component to receive personalized learning recommendations, such as based on competency gaps between their current competencies and the competencies that are required or preferred for their current work position type. Recommendations for learning activities can also be generated to reduce or eliminate competency gaps that result from target competencies independent of a current work position type (e.g., target competency gaps that are related to a future career path and/or are based on recommendations or requirements specified by a supervisor). The personalized learning recommendation information for employees is stored in a database 1126 on storage in the illustrated embodiment, but could instead be generated dynamically when needed in other embodiments.

In addition, various employee learning activity information and corresponding employee competency information is stored in databases 1124 and 1123 on storage respectively to track learning activity-related information (e.g., planned and completed learning activities) and competency-related information that is associated with employees. In some embodiments, an administrator may define initial competency and learning activity information for each new employee that joins the organization, or alternatively employees themselves could define their own competency and learning activity information. Subsequently, any changes to that learning activity information and/or competency information could be automatically tracked by the LM system and the Competency Management system.

Various performance information for the organization and the employees is also stored in databases 1129 and 1127 respectively. As previously noted, a variety of types of performance information may be tracked and stored by a variety of components (not shown). In addition, other information related to performance information may also be stored in the databases or elsewhere, such as information about various performance criteria with which the performance information can be rated and/or reported.

With learning activity information and performance information available, the Learning Activity Performance Relationship Reporter component can provide information to users about relationships between the learning activities and the performance information. In particular, in the illustrated embodiment the component can retrieve learning activity information for employees from database 1124, and can aggregate the retrieved information in a variety of ways (e.g., by organizational structure, location, category or type of learning activity, period of time, etc.). Similarly, the component can retrieve performance information for the organization (e.g., overall sales) and/or employees (e.g., performance review scores) from databases 1129 and 1127, and can aggregate the retrieved information in a variety of ways (e.g., by organizational structure, location, category or type of learning activity, period of time, etc.). The component can then relate the learning activity and performance information in a variety of ways (e.g., by correlating learning activity information to a performance measure or by determining a direct causal relationship between the learning activity and the performance measure), and can provide the relationship information in a variety of manners and forms (e.g., by generating an textual or graphical report to be presented to the user).

In some embodiments, the Learning Activity Performance Relationship Reporter component may also assist users in specifying information to be received, such as by providing (e.g., via one or more interactive user interfaces) information about types of learning activities, types of performance information and/or performance measures, types of relationships between learning activities and performance information and/or types of manners of presenting relationship information. While the component in the illustrated embodiment dynamically aggregates and/or separates learning activity and performance information, in other embodiments some or all such aggregations of information may instead by tracked and stored by various components. In addition, while not illustrated here, the Learning Activity Performance Relationship Reporter component or a similar component may also provide various information (e.g., reports) about learning activities completed by groups of one or more employees and/or about ratings of learning activity information based on various learning activity criteria.

As previously noted, employees can interact with the LM system and/or Competency Management system to receive a variety of types of functionality, such as to request and/or receive information about relationships between learning activities and performance information. Employees that are using organization client computers may perform such interactions via a Web browser 1159 (e.g., by accessing an employee relationship management section of a Web portal for the organization) executed in memory 1157 of a client computer by a CPU 1152, while in other embodiments other types of software (e.g., software specific to the LM system and/or the Competency Management system, such as proprietary software) could instead be used for the interactions. Information received from the LM system and/or the Competency Management system can be presented via various I/O devices 1154 (e.g., by the Web browser), or received information could instead be stored (e.g., on storage 1151 for later presentation and/or processing). In some embodiments, the storage may also contain various employee-specific information, such as access or authorization information needed to interact with the LM system and/or the Competency Management system, as well as calendar or schedule information (not shown) for an employee that may be used when scheduling future learning activities. While not illustrated here, in other embodiments users outside the organization may also be able to interact with various of the illustrated systems and components via external client computing devices, such as to receive information about relationships between learning activities and performance information from the Learning Activity Performance Relationship Reporter component.

Those skilled in the art will appreciate that the computing devices and computer systems 1100, 1150, 1170 and 1190 are merely illustrative and are not intended to limit the scope of the present invention. In particular, a “client” or “server” may comprise any combination of hardware and/or software that can interact and perform some or all of the described functionality, including computers, network devices, internet appliances, PDAs, wireless phones, pagers, electronic organizers, television-based systems and various other consumer products that include inter-communication capabilities. The devices and systems may also be connected to other devices that are not illustrated, including through one or more networks such as the Internet or via the World Wide Web. In addition, the functionality provided by the illustrated system components may in some embodiments be combined in fewer components or distributed in additional components. Similarly, in some embodiments the functionality of some of the illustrated components may not be provided and/or other additional functionality may be available.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software modules and/or components may execute in memory on another device and communicate with the illustrated computing device via inter-computer communication. Some or all of the system components or data structures may also be stored (e.g., as instructions or structured data) on a computer-readable medium, such as a hard disk, a memory, a network, or a portable article to be read by an appropriate drive. The system components and data structures can also be transmitted as generated data signals (e.g., as part of a carrier wave) on a variety of computer-readable transmission mediums, including wireless-based and wired/cable-based mediums. Accordingly, the present invention may be practiced with other computer system configurations.

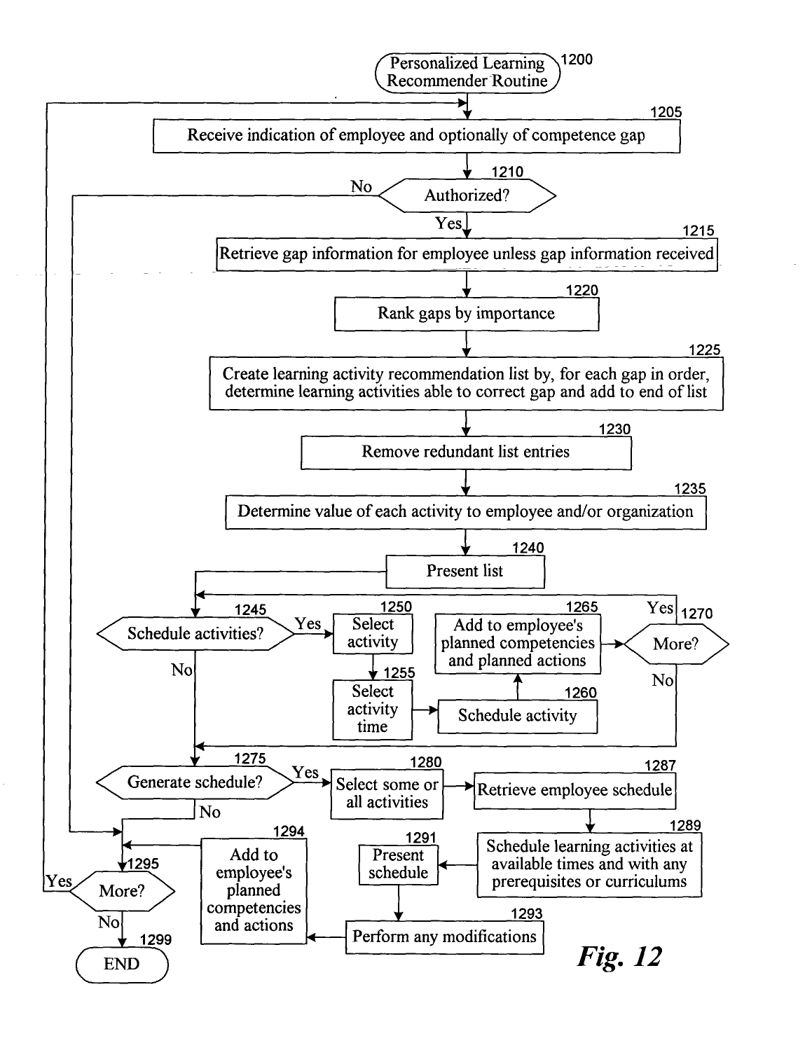

FIG. 12 is a flow diagram of an embodiment of the Personalized Learning Recommender routine 1200. The routine determines personalized recommendations of learning activities for an employee based on competency gaps associated with that employee, and presents that information for use by the employee.

The routine begins in step 1205 where an indication is received of an employee, and where competency gap information for the employee is optionally received. In step 1210, it is determined if the user is authorized to perform the routine, and if so the routine continues to step 1215 to retrieves competency gap information for the employee if it was not supplied in step 1205. After step 1215, the routine continues to step 1220 to rank the competency gaps in their order of importance. As previously discussed, such competency gap ranking can be performed in a variety of ways, such as based on assigned criticality of competency gaps (e.g., as assigned by the source of the competency gap, such as when the competency gap is from a definition for a work position type and the competency gap is for a required competency having that criticality value), a size of the competency gap, etc.

In step 1225, the routine creates a list of learning activity recommendations by determining learning activities able to correct the ranked gaps, such as learning activities that have corresponding associated resulting competencies. Information about learning activities can be retrieved from various sources, such as an internal and/or external server or by interacting with an appropriate component such as a learning activity scheduler component. In step 1230, any duplicate learning activity entries on the recommendation list are removed by retaining the first of each such learning activity on the list. If a learning activity was present on the list to correct two or more different competency gaps, the remaining learning activity entry is modified to reflect each competency gap that will be corrected. In step 1235, the value of each remaining learning activity is then determined (e.g., to the employee and/or to the organization), such as based on the importance of the corresponding competency gaps and/or by using an independent valuation system.

The routine then continues to step 1240 to present the list of learning activity recommendations with associated values to the user. If it is determined in step 1245 that the user would like to schedule one or more of the learning activities, the routine continues to step 1250 to select a particular learning activity. In step 1255, a particular instance of the learning activity is selected (if there is more than one) based on the activity time, and in step 1269 the activity is scheduled. In step 1265, the information for the scheduled activity is then added to planned actions of the employee, and expected resulting competencies from the learning activity are added to the planned competency information for the employee (e.g., by executing the Employee Competency Manager routine). If it is determined in step 1270 that there are more activities to be selected, the routine returns to step 1245. If not, or if it was instead initially determined in step 1245 that no activities were to be scheduled, the routine continues to step 1275 to determine whether to generate a schedule for some or all of the learning activities.

If so, the routine continues to step 1280 to select some or all of the learning activities (e.g., based on a received indication from the user), and in step 1287 retrieves schedule information for the employee. In step 1289, a schedule for the selected learning activities is then generated based on available times in the employee's schedule, taking into consideration any prerequisites or related courses from a curriculum that are also to be scheduled. In some embodiments, the user and/or employee may optionally be able to specify a time period over which the scheduled learning activities are to occur. The generated schedule is then presented to the user in step 1291, and in step 1293 the user can optionally make one or more modifications to the generated schedule. In step 1294, any remaining scheduled learning activities are then added to the planned actions for the employee, and the planned competencies of the employee are also updated to reflect those activities. After step 1294, or if it was instead determined in step 1275 not to generate a schedule or in step 1210 that the user was not authorized, the routine continues to step 1295 to determine whether to continue. If so, the routine returns to step 1205, and if not the routine continues to step 1299 and ends.

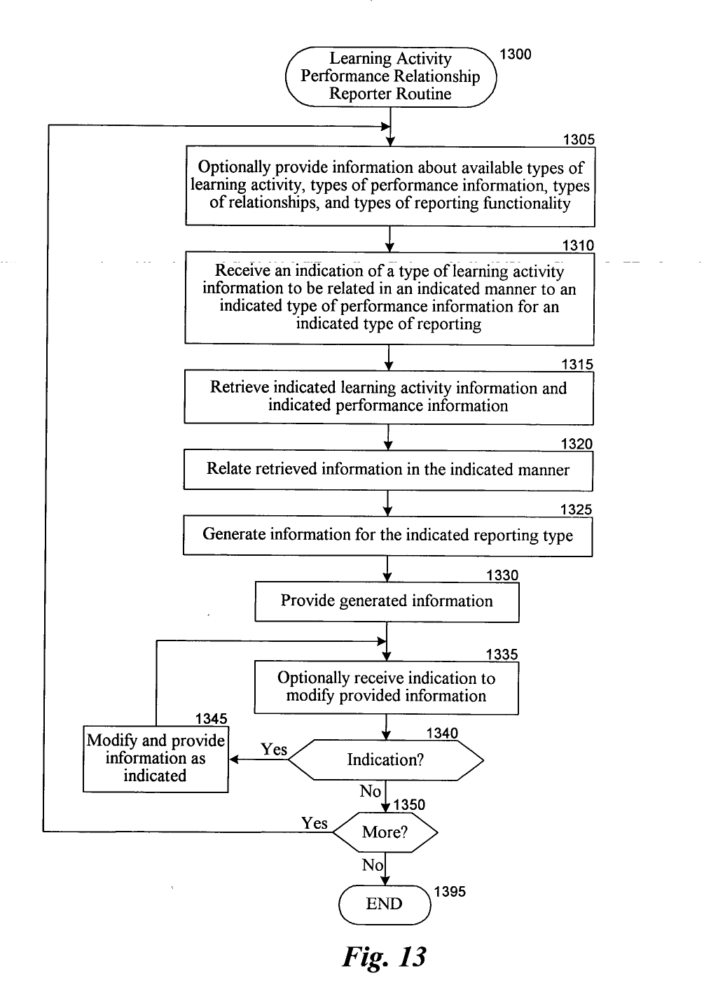

FIG. 13 is a flow diagram of the Learning Activity Performance Relationship Reporter routine 1300. The routine receives indications related to learning activities and performance information, determines relationships between the learning activities and the performance information, and provides the relationship information to a user.

The routine begins at step 1305 where information is optionally provided to a user about types of information available for the relationship determination in order to allow the user to select information to be used for the relationship determination. In the illustrated embodiment, information is provided about available types of learning activities (e.g., courses versus online exams, or categories of learning activities such as courses related to programming skills), types of performance information (e.g., financial information versus non-financial productivity information, or net final information versus gross financial information), types of relationships (e.g., correlation, causation, etc.) and types of reporting functionality (e.g., presenting a graphical report, presenting a textual report, providing textual information, etc.). In other embodiments, other types of information could be provided, either instead of or in addition to the illustrated types of information, such as information about specific learning activities, groups of employees, periods of time, learning activity criteria, performance criteria, etc.

After step 1305, the routine continues to step 1310 to receive indications of one or more types of learning activities to be related to one or more types of performance information in one or more indicated manners, and one or more types of reporting functionality with which to provide the relationship information. In other embodiments, other types of information could be received, either instead of or in addition to the illustrated types of information, such as information about specific learning activities, groups of employees, periods of time, learning activity criteria, performance criteria, etc. The routine in the illustrated embodiment then continues to step 1315 to retrieve learning activity information and performance information as indicated, although in other embodiments such information could instead be received in step 1310 (e.g., optionally).

After step 1315, the routine continues to step 1320 to relate the retrieved information in the indicated manner, such as based on various known techniques for relating groups of information. In step 1325, the routine then generates information based on the indicated reporting type, such as by generating one or more charts or other types of reports, and in step 1330 provides the generated information to the user. The routine continues to step 1335 where an indication is optionally received from the user to modify the provided information in one or more of various ways (e.g., to modify the type of relationship information provided and/or the information for which the relationship is determined). If it is determined in step 1340 that an indication is received, the routine continues to step 1345 to modify the information as requested and to provide modified information as appropriate, and then continues to step 1335. If it is instead determined in step 1340 that no indication was received, the routine continues to step 1350 to determine whether to continue. If so, the routine returns to step 1305, and if not the routine continues to step 1395 and ends.

While not part of the illustrated routine, in other embodiments additional functionality may be available from this or another routine, such as to provide information about learning activities (e.g., completed learning activities) for individuals and/or groups of multiple individuals and/or to provide information about ratings of learning activity information with respect to one or more learning activity criteria.

Those skilled in the art will also appreciate that in some embodiments the functionality provided by the routines discussed above may be provided in alternative ways, such as being split among more routines or consolidated into less routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

1. (canceled)

2. A method in a computing system for correlating changes in training of employees of an organization with corresponding changes in performance of the organization, the method comprising:
tracking training activities completed by the employees of the organization over a period of time;
tracking performance information for the organization over the period of time for each of multiple performance criteria; and
repeatedly providing information about correlations between training and performance changes by,
receiving from an employee an indication of a group of multiple employees and an indication of one or more of the multiple performance criteria;
determining changes in the training of the employees in the indicated employee group based on the tracked completed training activities;
for each of the indicated performance criteria, determining changes in the tracked performance information for that performance criteria that corresponds to the indicated employee group;
correlating the determined training changes for the indicated employee group with each of the determined changes in performance information for a performance criteria that corresponds to the indicated employee group;
generating a report indicating the correlations; and
presenting the generated report to the employee.

3. The method of claim 2 wherein each receiving of the indications of a group and of performance criteria from an employee includes receiving an indication of a specified time period that is less than the period of time for the tracking of the training activities and of the performance organization, and wherein the determining of the changes in the training and the determining of the changes in the performance information are performed for the specified time period.

4. The method of claim 2 wherein each receiving of the indications of a group and of performance criteria from an employee includes receiving an indication of one or more types of training activities, and wherein the determining of the changes in the training is performed for training activities of the indicated types.

5. The method of claim 2 including, before each correlating of determined training changes with determined performance information changes, receiving an indication of one or more training criteria and rating the determined training changes of the employees based on each of the indicated training criteria, and wherein the correlating includes correlating the determined training change ratings with the determined performance information changes.

6. The method of claim 5 wherein the determining of changes in tracked performance information for a performance criteria includes rating those determined performance information changes based on the performance criteria, and wherein the correlating includes correlating the determined training change ratings with the determined performance information change ratings.

7. The method of claim 2 wherein the indicated group of multiple employees is based on employees at a specified geographic location.

8. The method of claim 2 wherein the indicated group of multiple employees is based on employees that are part of a specified organizational structure.

9. The method of claim 2 wherein the indicated group of multiple employees is based on employees in a specified type of work position for the organization.

10. The method of claim 2 wherein each receiving of the indications of a group and of performance criteria from an employee includes presenting options to the employee for selecting from multiple groups of employees and from a plurality of performance criteria, and wherein the received indications of the employee group and the multiple performance criteria are based on selections by the employee.

11. The method of claim 2 wherein the organization provides an information portal from which each of the employees can repeatedly receive a page of information with information specific to that employee about correlations between training and performance changes for presentation on a computing device, and wherein the correlating is performed for an employee each time that the employee receives the page of information so that current correlation information can be presented to the employee as part of the presenting of that page of information.

12. The method of claim 2 including receiving an indication from at least one employee of one or more training criteria, rating training information for the employees in the indicated employee group based on the indicated training criteria, and providing a generated report that includes the rated training information.

13. The method of claim 2 including receiving an indication from at least one employee of a group of one or more employees, identifying completed training activities of those one or more employees, and providing a generated report that includes the identified completed training activities.

14-42. (canceled)
